(19) United States
(12) Patent Application Publication
(10) Pub. No.: US 2023/0189806 A1
(43) Pub. Date: Jun. 22, 2023

(54) FUNGICIDAL COMBINATIONS

(71) Applicants: UPL Corporation Limited, Port Louis (MU); UPL Europe LTD, Warrington (GB)

(72) Inventors: Jonatas Bredow Alves, Durham, NC (US); Charles Flood, Evesham (GB); Luis Gustavo Rodriguez Gonella, Tatuí (BR); Flavia Ferreira Megda, Campinas (BR)

(21) Appl. No.: 18/085,182

(22) Filed: Dec. 20, 2022

Related U.S. Application Data
(60) Provisional application No. 63/292,214, filed on Dec. 21, 2021.

(51) Int. Cl. A01N 43/74; A01N 43/653; A01P 3/00

(52) U.S. Cl. CPC A01N 43/74; A01N 43/653; A01P 3/00

(57) ABSTRACT

Described herein is a fungicidal combination including ipconazole and thiabendazole for controlling infestation by saprophytic phytopathogenic fungi in crops. Provided is a fungicidal combination including ipconazole and thiabendazole for controlling infestation by saprophytic phytopathogenic fungi in crops for seed treatment. Further described is a method of controlling phytopathogenic fungi.

### CROSS-REFERENCE TO RELATED APPLICATIONS

This application claims priority to U.S. Provisional Application 63/292,214 filed on Dec. 21, 2021, which is incorporated herein by reference in its entirety.

### FIELD OF THE INVENTION

The present disclosure relates to fungicidal combinations effective against phytopathogenic fungi. More particularly, the present disclosure relates to fungicidal combinations comprising ipconazole and thiabendazole to effectively control phytopathogenic fungi, including saprophytic plant fungi. The present disclosure relates to a method of controlling phytopathogenic fungi. The present disclosure also relates to a method for controlling Rhizoctonia genus fungi and Sclerotinia sclerotiorum.

### BACKGROUND

Achieving production of high-quality, nutritional crops with efficient yield, amidst the rampant onslaught of pest infestation in crops, is a priority for farmers. Thus, providing optimal growth conditions for plants under existing field conditions and protecting them from damage by pests including weeds, insects and fungal pathogenic microorganisms is incumbent on farmers. Plant diseases result in an annual estimated loss of 10-15% of the world's major crops, with direct economic losses. 70-80% of plant diseases are caused by pathogenic fungi. Phytopathogenic fungi have adverse effects on crop growth and yield. In recent years, fungal diseases of crops have become increasingly serious as they have severely affected crop yield and quality and have become a bottleneck for development of sustainable agriculture. The use of synthetic pesticides to control and inhibit fungal phytopathogens has become an integral part of modern agriculture and is one of the main reasons for a dramatic increase in crop productivity.

A major factor that decides the efficacy of agrochemicals is their unique mode of action. Fungicides usually attack a specific metabolic protein or a metabolic process in a phytopathogen and are therefore referred to as single-site inhibitors. Almost all single-site fungicides or systemic fungicides are high-risk fungicides because single mutations in genes encoding the target molecule are likely to prevent binding of the active fungicidal ingredient. The persistent use of single-site inhibitors could lead to occurrence of fungicide resistance or insensitivity. If only one or a few genes are involved, fungicide treatments lead to a selection of fungal subpopulations of either sensitive or extremely highly resistant strains.

The Rhizoctonia genus of fungi belong to family Ceratobasidiaceae, order Cantharellales, class Agaricomycetes, division Basidiomycota, and have a huge number of susceptible host plants. Rhizoctonia species are necrotrophic pathogens, that is, they kill host cells before colonizing them through the secretion of enzymes and toxins in advance of fungal growth. Rhizoctonia are soil-borne fungi, and are known to cause root rot, stem rot, damping-off and, in some cases, a blight of leaves, among other symptoms/diseases. Rhizoctonia are present in most soils with high survival rates and cause disease in almost all cultivated crops.

Rhizoctonia species are strong saprophytes. They survive for extended periods of time in the absence of living host plants by feeding on decaying organic matter. Losses from Rhizoctonia result from stand reduction in newly planted fields, premature death of diseased plants, and production of smaller seeds. Rhizoctonia solani can cause seed rot, root rot and lesions on hypocotyls. Damping-off occurs when germinating seedlings are infected prior to emergence. Reddish-brown, sunken lesions form on hypocotyls of young seedlings. The resulting firm, dry canker can girdle the seedling and cause it to collapse.

The yield losses due to Rhizoctonia sp. infestation in USA, Canada and Australia are reported to be up to 50%. Azalea, hydrangea, osteospermum, pittosporum, poinsettias, rosemary, and vine crops are among the susceptible crops to cutting rot. Celosia, gomphrena, impatiens, snapdragon, and vinca crops are among the susceptible crops to damping-off. Aster, dianthus, impatiens, poinsettias, pothos crops are among the susceptible crops to stem rot. Aglaonema, azalea, begonia, campanula, ferns, holly, impatiens, juniper, philodendron, poinsettias, and spathiphyllum crops are among the susceptible crops to root rot. Azalea, holly, juniper, and pittosporum crops are among the susceptible crops to aerial blight.

Demethylation inhibitors (a type of sterol synthesis inhibitors) are known for controlling Rhizoctonia fungi. They inhibit the biosynthesis of ergosterol, which is a major component of the plasma membrane of certain fungi and needed for fungal growth. Fungicidal inhibitors of β-tubulin assembly are known to control Rhizoctonia fungi. They are fungicidal compounds that exert their biological activities by preventing cell division through the inhibition of tubulin polymerization, which is the major component of microtubules. Rhizoctonia genus fungi have a wide range of host plants, excellent survival rate in soil, have huge number of countries affected by them, cause great loss of crop and seed yields throughout the world which make them a very difficult, important and urgent problem to address.

Sclerotinia sclerotiorum is one of the most devastating and cosmopolitan of plant pathogens. Diseases caused by this fungal pathogen include cottony rot, watery soft rot, stem rot, drop, crown rot, blossom blight and white mould. The fungus infects over 400 species of plants worldwide, including important crops and numerous weeds

Despite the persistent use of these single-site inhibitor fungicides or systemic fungicides to control pathogenic, saprophytic fungi in crops, the damage due to fungal infestation has been impactful in terms of economic losses and reduction in crop quality. Therefore, the present inventors have aimed at providing a novel, synergistic combination for efficaciously controlling fungal infestation in crops.

### SUMMARY

It is an object of the present disclosure to provide a fungicide combination for effectively controlling infestation by phytopathogenic fungi.

It is another object of the present disclosure to provide a synergistic fungicide combination for effectively controlling infestation by saprophytic phytopathogenic fungi.

It is another object of the present disclosure to provide a synergistic fungicide combination for effectively controlling infestation by saprophytic phytopathogenic fungi, wherein the combination is suitable for seed treatment.

It is another object of the present disclosure to provide a fungicide composition for controlling infestation by phytopathogenic fungi.

It is another object of the present disclosure to provide a seed treatment composition for controlling infestation by phytopathogenic fungi.

It is an object of the present disclosure to provide a method of controlling fungi using a synergistic combination, wherein the combination comprises at least one demethylation inhibitor fungicide and at least one β-tubulin assembly inhibitor fungicide.

It is another object of the present disclosure to provide a method of controlling saprophytic fungi using a synergistic combination comprising at least one demethylation inhibitor fungicide and at least one β-tubulin assembly inhibitor fungicide.

Another objective of the present disclosure is to provide a method of controlling Rhizoctonia fungi using a synergistic combination, wherein the combination comprises at least one demethylation inhibitor fungicide and at least one β-tubulin assembly inhibitor fungicide.

An object of the present disclosure is to provide the use of a fungicide combination comprising at least one demethylation inhibitor fungicide and at least one β-tubulin assembly inhibitor fungicide for controlling fungal infestation in crops.

Another object of the present disclosure is to provide the use of a fungicide composition comprising at least one demethylation inhibitor fungicide and at least one β-tubulin assembly inhibitor fungicide for controlling fungal infestation in crops.

The present disclosure provides a fungicidal combination comprising at least one demethylation inhibitor fungicide and at least one β-tubulin assembly inhibitor fungicide.

In an aspect, the present disclosure provides a synergistic fungicidal combination comprising

(i) at least one demethylation inhibitor fungicide comprising azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, ipconazole, mefentrifluconazole, metconazole, myclobutanil, penconazole, propiconazole, simeconazole, tebuconazole, tetraconazole, triadimefon, triadimenol, triticonazole, prothioconazole, or a combination thereof; and

(ii) at least one β-tubulin assembly fungicide comprising benomyl, carbendazim, fuberidazole, thiabendazole, thiophanate, thiophanate-methyl, or a combination thereof.

In an aspect, the present disclosure provides a synergistic fungicidal combination comprising ipconazole and thiabendazole.

In an aspect, the present disclosure provides a synergistic fungicidal combination comprising ipconazole and thiabendazole, wherein the combination is suitable for treatment of seeds.

In another aspect, the present disclosure provides a synergistic fungicidal composition for effectively controlling fungal infestation in crops, said composition comprising

(i) at least one demethylation inhibitor fungicide comprising azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, ipconazole, mefentrifluconazole, metconazole, myclobutanil, penconazole, propiconazole, simeconazole, tebuconazole, tetraconazole, triadimefon, triadimenol, triticonazole, prothioconazole, or a combination thereof;

(ii) at least one β-tubulin assembly fungicide comprising benomyl, carbendazim, fuberidazole, thiabendazole, thiophanate, thiophanate-methyl, or a combination thereof; and (iii) an agriculturally acceptable excipient.

In an aspect, the present disclosure provides a synergistic fungicidal composition comprising ipconazole, thiabendazole and an agriculturally acceptable excipient for effectively controlling fungal infestation in crops.

The present disclosure provides a seed treatment composition comprising at least one demethylation inhibitor fungicide and at least one β-tubulin assembly inhibitor fungicide.

In an aspect, the present disclosure provides a seed treatment composition comprising ipconazole, thiabendazole and an agriculturally acceptable excipient for effectively controlling fungal infestation in crops.

In one aspect, the present disclosure provides a method of controlling phytopathogenic fungi by applying a synergistic combination comprising at least one demethylation inhibitor fungicide and at least one β-tubulin assembly inhibitor fungicide, at a locus of a plant, a plant part, or a propagation material.

In another aspect, the present disclosure provides a method of controlling phytopathogenic fungi by applying a synergistic combination at a locus of a plant, a plant part or a propagation material, the combination comprising:

(i) at least one demethylation inhibitor fungicide comprising azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, ipconazole, mefentrifluconazole, metconazole, myclobutanil, penconazole, propiconazole, simeconazole, tebuconazole, tetraconazole, triadimefon, triadimenol, triticonazole, prothioconazole, or a combination thereof; and

(ii) at least one β-tubulin assembly fungicide comprising benomyl, carbendazim, fuberidazole, thiabendazole, thiophanate, thiophanate-methyl, or a combination thereof.

In one aspect, the present disclosure provides a method of controlling phytopathogenic fungi by applying a synergistic combination comprising ipconazole and thiabendazole at a locus of a plant, a plant part or a propagation material.

In another aspect, the present disclosure provides a method of controlling Rhizoctonia fungi infestation in crops by applying a combination comprising at least one demethylation inhibitor fungicide and at least one β-tubulin assembly inhibitor fungicide.

In another aspect, the present disclosure provides a method of controlling Rhizoctonia fungi using a synergistic combination, wherein the combination comprises:

(i) at least one demethylation inhibitor fungicide comprising azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, ipconazole, mefentrifluconazole, metconazole, myclobutanil, penconazole, propiconazole, simeconazole, tebuconazole, tetraconazole, triadimefon, triadimenol, triticonazole, prothioconazole, or a combination thereof;

(ii) and at least one β-tubulin assembly fungicide comprising benomyl, carbendazim, fuberidazole, thiabendazole, thiophanate, thiophanate-methyl, or a combination thereof.

In another aspect, the present disclosure provides a method of controlling Rhizoctonia fungi infestation in crops by applying a combination comprising ipconazole and thiabendazole.

In another aspect, the present disclosure provides a method of controlling Sclerotinia sclerotiorum infestation in crops by applying a combination comprising ipconazole and thiabendazole.

In yet another aspect, the present disclosure provides the use of a fungicidal combination comprising at least one demethylation inhibitor fungicide and at least one β-tubulin assembly inhibitor fungicide for controlling fungal infestation in crops.

In yet another aspect, the present disclosure provides the use of a fungicidal combination comprising ipconazole and thiabendazole for controlling fungal infestation in crops.

In yet another aspect, the present disclosure provides the use of a fungicidal composition comprising at least one demethylation inhibitor fungicide and at least one β-tubulin assembly inhibitor fungicide for controlling fungal infestation in crops.

In yet another aspect, the present disclosure provides the use of a fungicidal composition comprising ipconazole and thiabendazole for controlling fungal infestation in crops.

### DETAILED DESCRIPTION

Before describing the present disclosure in detail, it is to be understood that this disclosure is not limited to particularly exemplified systems or process parameters that may of course, vary. It is also to be understood that the terminology used herein is for the purpose of describing particular embodiments of the disclosure only and is not intended to limit the scope of the disclosure in any manner. The use of examples anywhere in this specification including examples of any terms discussed herein is illustrative only, and in no way limits the scope and meaning of the disclosure or of any exemplified term.

It must be noted that, as used in this specification, the singular forms “a,” “an” and “the” include plural referents unless the content clearly dictates otherwise. The terms “preferred” and “preferably” refer to embodiments of the disclosure that may afford certain benefits, under certain circumstances.

As used herein, the terms “comprising” “including,” “having,” “containing,” “involving,” and the like are to be understood to be open-ended, i.e., to mean including but not limited to.

The term “plant propagation material” refers to the parts of the plant, such as seeds, which can be used for the propagation of the plant and vegetative plant material. There may be mentioned, e.g., the seeds (in the strict sense), roots, fruits, tubers, bulbs, rhizomes as parts of plants. Germinated plants or young plants, which may be transplanted after germination or after emergence from the soil, are included herein.

The term “seed” embraces seeds and plant propagules of all kinds including but not limited to true seeds, seed pieces, suckers, corms, bulbs, fruit, tubers, grains, cuttings, cut shoots and the like. In a preferred embodiment a seed is a true seed.

The term “seeds” may also include transgenic seeds, i.e., seeds of a transgenic plant. As used herein “transgenic plant” means a plant or progeny thereof derived from a transformed plant cell or protoplast, wherein the plant DNA contains an introduced exogenous DNA molecule not originally present in a native, non-transgenic plant of the same strain

“Fungicidal” refers to the ability of a substance to decrease or inhibit growth of fungi.

To “control” or “controlling” fungus means to inhibit, and/or suppress the ability of fungus to grow and/or reproduce, or to limit fungus damage or loss in crop plants or denotes control and prevention of a disease. Controlling effects include all deviation from natural development, for example: killing, retardation, decrease of the disease.

The term “locus” as used herein shall denote the vicinity of a desired crop in which control of the spread of phytopathogenic fungi is desired. The locus includes the vicinity of desired crop plants wherein the phytopathogenic fungi infection has either emerged or is most likely to emerge or is yet to emerge.

According to the present disclosure, “increased yield” of an agricultural plant means that the yield of a product of the respective plant is increased by a measurable amount over the yield of the same product of the plant produced under the same conditions, but without the application of the compositions described herein.

According to the present disclosure, it is preferred that the crop yield be increased by at least 0.5%, preferred at least 2%, more preferred at least 5%, upon application of the combinations and compositions described herein. Accordingly, there is provided a fungicidal combination useful in combating Rhizoctonia fungi. The composition also increases the vigor/yield of the plant.

Surprisingly, the problems explained above are solved by the combination of the active compounds and/or methods as defined herein. The present inventors have unexpectedly found that the application of the fungicidal combination comprising a demethylation inhibitor fungicide and a β-tubulin assembly inhibitor fungicide results in a significant enhancement in the crop plant health, crop yield, and in the reduction of fungal diseases caused by phytopathogenic fungi. More particularly, the present inventors have unexpectedly found that the application of the present fungicidal combination comprising ipconazole and thiabendazole in a specific ratio result in a significant enhancement in the crop plant health, crop yield as well as in the reduction of fungal diseases caused by saprophytic plant fungi such as Rhizoctonia sp., and Sclerotinia sclerotiorum. The present inventors have treated seeds of crops susceptible to fungal infestation by phytopathogenic fungi, mostly saprophytic fungi, with the fungicidal combination comprising ipconazole and thiabendazole, to achieve exceptionally efficacious and synergistic control of pathogenic fungi. The improvement in crop health and reduction in fungal diseases have been brought about by applying the present combination comprising at least one demethylation inhibitor fungicide and at least one β-tubulin assembly fungicide.

The present disclosure provides a fungicidal combination comprising at least one demethylation inhibitor fungicide; and at least one β-tubulin assembly inhibitor fungicide for effectively controlling phytopathogenic fungi.

In an embodiment, the present disclosure provides a fungicidal combination for controlling phytopathogenic fungi comprising:

(i) at least one demethylation inhibitor fungicide; and

(ii) at least one β-tubulin assembly inhibitor fungicide.

In an embodiment, the present disclosure provides a fungicidal combination for controlling phytopathogenic fungi comprising:

(i) at least one demethylation inhibitor fungicide; and

(ii) at least one β-tubulin assembly inhibitor fungicide;

wherein the combination is suitable for seed treatment and effectively controls saprophytic phytopathogenic fungi.

In an embodiment, the present disclosure provides a fungicidal combination for controlling saprophytic phytopathogenic fungi comprising:

(i) at least one demethylation inhibitor fungicide; and

(ii) at least one β-tubulin assembly inhibitor fungicide;

wherein the said phytopathogenic fungi is Rhizoctonia sp., specifically Rhizoctonia solani, or Sclerotinia sp., specifically Sclerotinia sclerotiorum.

In an embodiment, there is provided, a synergistic fungicidal combination for controlling Rhizoctonia sp., comprising:

(i) at least one demethylation inhibitor fungicide; and

(ii) at least one β-tubulin assembly inhibitor fungicide.

In an embodiment, the present disclosure provides a synergistic fungicidal combination for controlling Sclerotinia sclerotiorum fungi comprising:

(i) at least one demethylation inhibitor fungicide; and

(ii) at least one β-tubulin assembly inhibitor fungicide.

In another embodiment, the demethylation inhibitor fungicide comprises azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, ipconazole, mefentrifluconazole, metconazole, myclobutanil, penconazole, propiconazole, simeconazole, tebuconazole, tetraconazole, triadimefon, triadimenol, triticonazole, prothioconazole, or a combination thereof.

In another embodiment, the β-tubulin assembly inhibitor fungicide comprises benomyl, carbendazim, fuberidazole, thiabendazole, thiophanate, thiophanate-methyl, or a combination thereof.

In an embodiment, there is provided, a synergistic fungicidal combination for controlling fungal infestation in crops comprising:

(i) at least one demethylation inhibitor fungicide comprising azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, ipconazole, mefentrifluconazole, metconazole, myclobutanil, penconazole, propiconazole, simeconazole, tebuconazole, tetraconazole, triadimefon, triadimenol, triticonazole, prothioconazole, or a combination thereof; and

(ii) at least one β-tubulin assembly inhibitor fungicide comprising benomyl, carbendazim, fuberidazole, thiabendazole, thiophanate, thiophanate-methyl, or a combination thereof.

In an embodiment, the demethylation inhibitor fungicide is tebuconazole.

In an embodiment, the demethylation inhibitor fungicide is prothioconazole.

In an embodiment, the demethylation inhibitor fungicide is cyproconazole.

In an embodiment, the demethylation inhibitor fungicide is mefentrifluconazole.

In a preferred embodiment, the demethylation inhibitor fungicide is ipconazole.

In an embodiment, the β-tubulin assembly inhibitor fungicide is thiophanate.

In an embodiment, the β-tubulin assembly inhibitor fungicide is carbendazim.

In a preferred embodiment, the β-tubulin assembly inhibitor fungicide is thiabendazole.

In all fungicidal combinations embodying the principle of the instant disclosure, demethylation inhibitor fungicides include their derivatives such as salts, esters, ethers, solvates, hydrates and polymorphs.

In all fungicidal combinations embodying the principle of the instant disclosure, β-tubulin assembly inhibitor fungicides include their derivatives such as salts, esters, ethers, solvates, hydrates and polymorphs.

A salt includes salts that retain the biological effectiveness and properties of the active ingredients of demethylation inhibitor fungicides and β-tubulin assembly inhibitor fungicides, and which are not biologically or otherwise undesirable, and include derivatives of the disclosed compounds in which the parent compound is modified by making inorganic and organic, non-toxic, acid or base addition salts thereof. The salts can be synthesized from the parent compound by conventional chemical methods.

In the current specification, for the sake of brevity, demethylation inhibitor fungicides are sometimes referred to by the corresponding short references as mentioned in Table 1.

TABLE 1

| Sr. | | |
|---|---|---|
| No. | Demethylation inhibitor fungicides | Short reference |
| 1. | Azaconazole | A (1) |
| 2. | Bitertanol | A (2) |
| 3. | Bromuconazole | A (3) |
| 4. | Cyproconazole | A (4) |
| 5. | Difenoconazole | A (5) |
| 6. | Diniconazole | A (6) |
| 7. | Epoxiconazole | A (7) |
| 8. | Etaconazole | A (8) |
| 9. | Fenbuconazole | A (9) |
| 10. | Fluquinconazole | A (10) |
| 11. | Flusilazole | A (11) |
| 12. | Flutriafol | A (12) |
| 13. | Hexaconazole | A (13) |
| 14. | Imibenconazole | A (14) |
| 15. | Ipconazole | A (15) |
| 16. | Mefentrifluconazole | A (16) |
| 17. | Metconazole | A (17) |
| 18. | Myclobutanil | A (18) |
| 19. | Penconazole | A (19) |
| 20. | Propiconazole | A (20) |
| 21. | Simeconazole | A (21) |
| 22. | Tebuconazole | A (22) |
| 23. | Tetraconazole | A (23) |
| 24. | Triadimefon | A (24) |
| 25. | Triadimenol | A (25) |
| 26. | Triticonazole | A (26) |
| 27. | Prothioconazole | A (27) |

In the current specification, for the sake of brevity, β-tubulin assembly inhibitor fungicides are sometimes referred to by the corresponding short references as mentioned in Table 2.

TABLE 2

| Sr. | | |
|---|---|---|
| No. | β-tubulin assembly inhibitor fungicides | Short reference |
| 1. | Benomyl | B (1) |
| 2. | Carbendazim | B (2) |
| 3. | Fuberidazole | B (3) |
| 4. | Thiabendazole | B (4) |
| 5. | Thiophanate | B (5) |
| 6. | Thiophanate-Methyl | B (6) |

Table 3 provides a list of some examples of fungicidal combinations according to the present disclosure.

TABLE 3

| | Demethylation inhibitor | |
|---|---|---|
| Sr. | fungicides as part of the | β-tubulin assembly inhibitor fungicide as part of the |
| No. | combination | combination |
| 1. | A (1) | One or more of B (1), B (2), B (3), B (4), B (5), and B (6) |
| 2. | A (2) | One or more of B (1), B (2), B (3), B (4), B (5), and B (6) |
| 3. | A (3) | One or more of B (1), B (2), B (3), B (4), B (5), and B (6) |
| 4. | A (4) | One or more of B (1), B (2), B (3), B (4), B (5), and B (6) |
| 5. | A (5) | One or more of B (1), B (2), B (3), B (4), B (5), and B (6) |
| 6. | A (6) | One or more of B (1), B (2), B (3), B (4), B (5), and B (6) |
| 7. | A (7) | One or more of B (1), B (2), B (3), B (4), B (5), and B (6) |
| 8. | A (8) | One or more of B (1), B (2), B (3), B (4), B (5), and B (6) |
| 9. | A (9) | One or more of B (1), B (2), B (3), B (4), B (5), and B (6) |
| 10. | A (10) | One or more of B (1), B (2), B (3), B (4), B (5), and B (6) |
| 11. | A (11) | One or more of B (1), B (2), B (3), B (4), B (5), and B (6) |
| 12. | A (12) | One or more of B (1), B (2), B (3), B (4), B (5), and B (6) |
| 13. | A (13) | One or more of B (1), B (2), B (3), B (4), B (5), and B (6) |
| 14. | A (14) | One or more of B (1), B (2), B (3), B (4), B (5), and B (6) |
| 15. | A (15) | One or more of B (1), B (2), B (3), B (4), B (5), and B (6) |
| 16. | A (16) | One or more of B (1), B (2), B (3), B (4), B (5), and B (6) |
| 17. | A (17) | One or more of B (1), B (2), B (3), B (4), B (5), and B (6) |
| 18. | A (18) | One or more of B (1), B (2), B (3), B (4), B (5), and B (6) |
| 19. | A (19) | One or more of B (1), B (2), B (3), B (4), B (5), and B (6) |
| 20. | A (20) | One or more of B (1), B (2), B (3), B (4), B (5), and B (6) |
| 21. | A (21) | One or more of B (1), B (2), B (3), B (4), B (5), and B (6) |
| 22. | A (22) | One or more of B (1), B (2), B (3), B (4), B (5), and B (6) |
| 23. | A (23) | One or more of B (1), B (2), B (3), B (4), B (5), and B (6) |
| 24. | A (24) | One or more of B (1), B (2), B (3), B (4), B (5), and B (6) |
| 25. | A (25) | One or more of B (1), B (2), B (3), B (4), B (5), and B (6) |
| 26. | A (26) | One or more of B (1), B (2), B (3), B (4), B (5), and B (6) |
| 27. | A (27) | One or more of B (1), B (2), B (3), B (4), B (5), and B (6) |

In any of the embodiments, the Rhizoctonia genus, includes Rhizoctonia solani species.

As used throughout the specification, Rhizoctonia solani includes Thanatephorus cucumeris, which is a synonym for the same fungus, when it is in a different state/phase/and to also include any other names assigned to it now and in future.

As used throughout the specification, Rhizoctonia solani must be understood as including all states/phases.

In a preferred embodiment, the present disclosure provides a fungicidal combination for controlling fungal infestation in crops, the combination comprising ipconazole and thiabendazole.

In a preferred embodiment, the present disclosure provides a synergistic fungicidal combination for controlling fungal infestation in crops, the combination comprising ipconazole and thiabendazole.

In another preferred embodiment, the present disclosure provides a fungicidal combination for controlling saprophytic fungal infestation in crops, the combination comprising ipconazole and thiabendazole.

In another preferred embodiment, the present disclosure provides a fungicidal combination for controlling saprophytic fungal infestation in crops, the combination comprising ipconazole and thiabendazole, wherein the said phytopathogenic fungi is Rhizoctonia sp. such as Rhizoctonia solani or Sclerotinia sp. such as Sclerotinia sclerotiorum.

In another preferred embodiment, there is provided a synergistic fungicidal combination for controlling Rhizoctonia fungi, said combination comprising ipconazole and thiabendazole.

In another preferred embodiment, the present disclosure provides a synergistic fungicidal combination for controlling Rhizoctonia solani, said combination comprising ipconazole and thiabendazole.

In another preferred embodiment, there is provided, a synergistic fungicidal combination for controlling Sclerotinia sclerotiorum, said combination comprising ipconazole and thiabendazole.

In an embodiment, the present disclosure provides a fungicidal combination for controlling phytopathogenic fungi in crops comprising:

(i) at least one demethylation inhibitor fungicide; and

(ii) at least one β-tubulin assembly inhibitor fungicide;

wherein the ratio of the demethylation inhibitor fungicide and the β-tubulin assembly inhibitor fungicide is 0.5:100 to 100:0.5, 1:50 to 50:1, or 1:25 to 25:1.

In an embodiment, the present disclosure provides a fungicidal combination for controlling phytopathogenic fungi comprising:

(i) at least one demethylation inhibitor fungicide; and

(ii) at least one β-tubulin assembly inhibitor fungicide;

wherein the ratio of the demethylation inhibitor fungicide and the β-tubulin assembly inhibitor fungicide is 0.5:10 to 10:0.5.

In a preferred embodiment, the present disclosure provides a fungicidal combination for controlling phytopathogenic fungi comprising:

(i) at least one demethylation inhibitor fungicide; and

(ii) at least one β-tubulin assembly inhibitor fungicide;

wherein the ratio of the demethylation inhibitor fungicide and the β-tubulin assembly inhibitor fungicide is 1:10 to 10:1.

In a preferred embodiment, the present disclosure provides a fungicidal combination for controlling phytopathogenic fungi comprising:

(i) at least one demethylation inhibitor fungicide; and

(ii) at least one β-tubulin assembly inhibitor fungicide;

wherein the ratio of the demethylation inhibitor fungicide and the β-tubulin assembly inhibitor fungicide is 1:8 to 8:1.

In a preferred embodiment, the present disclosure provides a fungicidal combination for controlling phytopathogenic fungi comprising:

(i) at least one demethylation inhibitor fungicide; and

(ii) at least one β-tubulin assembly inhibitor fungicide;

wherein the ratio of the demethylation inhibitor fungicide and the β-tubulin assembly inhibitor fungicide is 1:5 to 5:1.

In an embodiment, the present disclosure provides a fungicidal combination for controlling phytopathogenic fungi comprising:

(i) at least one demethylation inhibitor fungicide; and

(ii) at least one β-tubulin assembly inhibitor fungicide;

wherein the ratio of the demethylation inhibitor fungicide and the β-tubulin assembly inhibitor fungicide is 1:2 to 2:1.

In an embodiment, the present disclosure provides a fungicidal combination for controlling phytopathogenic fungi comprising:

(i) at least one demethylation inhibitor fungicide; and

(ii) at least one β-tubulin assembly inhibitor fungicide;

wherein the ratio of the demethylation inhibitor fungicide and the β-tubulin assembly inhibitor fungicide is 1:1.

In an embodiment, the present disclosure provides a fungicidal combination for controlling phytopathogenic fungi comprising ipconazole and thiabendazole in a ratio of 0.5:10 to 10:0.5.

In a preferred embodiment, the present disclosure provides a fungicidal combination for controlling phytopathogenic fungi comprising ipconazole and thiabendazole in a ratio of 1:10 to 10:1.

In a preferred embodiment, the present disclosure provides a fungicidal combination for controlling phytopathogenic fungi comprising ipconazole and thiabendazole in a ratio of 1:8 to 8:1.

In a preferred embodiment, the present disclosure provides a fungicidal combination for controlling phytopathogenic fungi comprising ipconazole and thiabendazole in a ratio of 1:5 to 5:1.

In a preferred embodiment, the present disclosure provides a fungicidal combination for controlling phytopathogenic fungi comprising ipconazole and thiabendazole in a ratio of 1:9.

In a preferred embodiment, the present disclosure provides a fungicidal combination for controlling phytopathogenic fungi comprising ipconazole and thiabendazole in a ratio of 1:8.

In a preferred embodiment, the present disclosure provides a fungicidal combination for controlling phytopathogenic fungi comprising ipconazole and thiabendazole in a ratio of 1:6.

In an embodiment, the present disclosure provides a fungicidal combination for controlling phytopathogenic fungi comprising ipconazole and thiabendazole in a ratio of 1:2 to 2:1.

In an embodiment, the present disclosure provides a fungicidal combination for seed treatment comprising:

(i) at least one demethylation inhibitor fungicide;

(ii) at least one β-tubulin assembly inhibitor fungicide; and

(iii) an inert filler;

wherein the ratio of the demethylation inhibitor fungicide and the β-tubulin assembly inhibitor fungicide is 0.5:100 to 100:0.5, 1:50 to 50:1, or 1:25 to 25:1;

wherein the said combination controls saprophytic, phytopathogenic fungi.

In an embodiment, the present disclosure provides a fungicidal combination for seed treatment comprising:

(i) at least one demethylation inhibitor fungicide;

(ii) at least one β-tubulin assembly inhibitor fungicide; and

(iii) an inert filler;

wherein the ratio of the demethylation inhibitor fungicide and the β-tubulin assembly inhibitor fungicide is 0.5:10 to 10:0.5;

wherein the said combination controls saprophytic, phytopathogenic fungi.

In a preferred embodiment, the present disclosure provides a fungicidal combination for seed treatment comprising:

(i) at least one demethylation inhibitor fungicide;

(ii) at least one β-tubulin assembly inhibitor fungicide; and

(iii) an inert filler;

wherein the ratio of the demethylation inhibitor fungicide and the β-tubulin assembly inhibitor fungicide is 1:10 to 10:1;

wherein the said combination controls saprophytic, phytopathogenic fungi.

In a preferred embodiment, the present disclosure provides a fungicidal combination for seed treatment comprising:

(i) at least one demethylation inhibitor fungicide;

(ii) at least one β-tubulin assembly inhibitor fungicide; and

(iii) an inert filler;

wherein the ratio of the demethylation inhibitor fungicide and the β-tubulin assembly inhibitor fungicide is 1:8 to 8:1;

wherein the said combination controls saprophytic, phytopathogenic fungi.

In another embodiment, the present disclosure provides a fungicidal combination for seed treatment:

(i) at least one demethylation inhibitor fungicide;

(ii) at least one β-tubulin assembly inhibitor fungicide; and

(iii) an inert filler;

wherein the ratio of the demethylation inhibitor fungicide and the β-tubulin assembly inhibitor fungicide is 1:2 to 2:1;

wherein the said combination controls saprophytic, phytopathogenic fungi.

In an embodiment, the present disclosure provides fungicidal combination for seed treatment comprising:

(i) at least one demethylation inhibitor fungicide;

(ii) at least one β-tubulin assembly inhibitor fungicide; and

(iii) an inert filler;

wherein the ratio of the demethylation inhibitor fungicide and the β-tubulin assembly inhibitor fungicide is 1:6;

wherein the said combination controls saprophytic, phytopathogenic fungi.

In a preferred embodiment, the present disclosure provides a fungicidal combination for seed treatment comprising ipconazole, thiabendazole and an inert material, wherein ipconazole and thiabendazole are in a ratio of 0.5:10 to 10:0.5, wherein said combination controls saprophytic, phytopathogenic fungi.

In a preferred embodiment, the present disclosure provides a fungicidal combination for seed treatment comprising ipconazole, thiabendazole and an inert material, wherein ipconazole and thiabendazole are in a ratio of 1:5 to 5:1, wherein said combination controls saprophytic, phytopathogenic fungi.

In a preferred embodiment, the present disclosure provides a fungicidal combination for seed treatment comprising ipconazole, thiabendazole and an inert material, wherein ipconazole and thiabendazole are in a ratio of 1:2 to 2:1, wherein said combination controls saprophytic, phytopathogenic fungi.

In a preferred embodiment, the present disclosure provides a fungicidal combination for seed treatment comprising ipconazole, thiabendazole and an inert material, wherein ipconazole and thiabendazole are in a ratio of 1:1, wherein said combination controls saprophytic, phytopathogenic fungi.

In an embodiment, the combinations of the present disclosure comprise at least a third additional fungicide or an herbicide or an insecticide.

In an embodiment, the present invention provides a synergistic fungicidal combination comprising:

(i) a demethylation inhibitor fungicide applied in an amount ranging from 1 g/100 kg of seeds to 20 g/100 kg of seeds; and

(ii) a β-tubulin assembly inhibitor fungicide applied in an amount ranging from 1 g/100 kg of seeds to 80 g/100 kg of seeds.

In another embodiment, the present invention provides synergistic fungicidal combination comprising:

(i) a demethylation inhibitor fungicide applied in an amount ranging from 1 g/100 kg of seeds to 10 g/100 kg of seeds; and

(ii) a β-tubulin assembly inhibitor fungicide applied in an amount ranging from 1 g/100 kg of seeds to 75 g/100 kg of seeds.

In another embodiment, the present invention provides a synergistic fungicidal combination comprising:

(i) a demethylation inhibitor fungicide applied in an amount ranging from 1 g/100 kg of seeds to 8 g/100 kg of seeds; and

(ii) a β-tubulin assembly inhibitor fungicide applied in an amount ranging from 1 g/100 kg of seeds to 70 g/100 kg of seeds.

In another embodiment, the present invention provides a synergistic fungicidal combination comprising:

(i) a demethylation inhibitor fungicide applied in an amount ranging from 1 g/100 kg of seeds to 8 g/100 kg of seeds; and

(ii) a β-tubulin assembly inhibitor fungicide applied in an amount ranging from 5 g/100 kg of seeds to 65 g/100 kg of seeds.

In an embodiment, the present invention provides a synergistic fungicidal combination comprising:

(i) ipconazole applied in an amount ranging from 1 g/100 kg of seeds to 20 g/100 kg of seeds; and

(ii) thiabendazole applied in an amount ranging from 1 g/100 kg of seeds to 80 g/100 kg of seeds.

In another embodiment, the present invention provides a synergistic fungicidal combination comprising:

(i) ipconazole applied in an amount ranging from 1 g/100 kg of seeds to 10 g/100 kg of seeds; and

(ii) thiabendazole applied in an amount ranging from 1 g/100 kg of seed to 75 g/100 kg of seeds.

In another embodiment, the present invention provides a synergistic fungicidal combination comprising;

(i) ipconazole applied in an amount ranging from 1 g/100 kg of seed to 8 g/100 kg of seeds; and

(ii) thiabendazole applied in an amount ranging from 1 g/100 kg of seed to 70 g/100 kg of seeds.

In another embodiment, the present invention provides a synergistic fungicidal combination comprising;

(i) ipconazole applied in an amount ranging from 1 g/100 kg of seed to 8 g/100 kg of seeds; and

(ii) thiabendazole applied in an amount ranging from 5 g/100 kg of seed to 65 g/100 kg of seeds.

In an embodiment, the combinations of the present disclosure comprise at least an additional fungicide such as systemic fungicides.

In an embodiment, the systemic fungicide may be a single fungicide or a combination of one or more systemic fungicides.

In an embodiment, the systemic fungicide is a combination of at least two fungicides.

In an embodiment, the systemic fungicides in the combinations may be selected from nucleic acid synthesis inhibitors, cytoskeleton and motor protein inhibitors, amino acids and protein synthesis inhibitors, respiration process inhibitors, signal transduction inhibitors, lipid synthesis and membrane integrity disruptors, sterol biosynthesis inhibitors, melanin synthesis inhibitors, cell wall biosynthesis inhibitors, melanin synthesis inhibitor in cell wall, host plant defense inducers, fungicides with unknown modes of action, fungicide with no classification, or biologicals with multiple mode of action.

Thus, in an embodiment, the nucleic acid synthesis inhibitor fungicides may be selected from acylalanines such as benalaxyl, benalaxyl-M (kiralaxyl), furalaxyl, metalaxyl, metalaxyl-m (mefenoxam), oxazolidinones such as oxadixyl, butyrolactones such as ofurace, hydroxy-(2-amino-) pyrimidines such as bupirimate, dimethirimol, ethirimol, isoxazoles such as hymexazole, isothiazolones such as octhilinone, carboxylic acids such as oxolinic acid.

In an embodiment, the cytoskeleton and motor protein inhibitors may be benzimidazoles such as benomyl, carbendazim, fuberidazole, thiabendazole, thiophanates such as thiophanate, thiophanate-methyl, N-phenyl carbamates such as diethofencarb, toluamides such as zoxamide, thiazole carboxamides such as ethaboxam, phenylureas such as pencycuron, benzamides such as fluopicolide, cyanoacrylates such as phenamacril.

In an embodiment, the respiration process inhibitor fungicides may be selected from pyrimidinamines such diflumetorim, pyrazole-5-carboxamides such as tolfenpyrad, strobilurins such as azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, dimoxystrobin, fenaminostrobin, metominostrobin, trifloxystrobin, famoxadone, fluoxastrobin, fenamidone, pyribencarb and mixtures thereof, oxazolidine-diones such as famoxadone, Imidazolinones such as fenamidone, benzyl-carbamates such as pyribencarb, N-methoxy-(phenyl-ethyl)-pyrazole-carboxamides such as Pyrimidinamines such as diflumetorim, cyano-imidazole such as cyazofamid, sulfamoyl-triazole such as amisulbrom, dinitrophenyl crotonates such as binapacryl, meptyldinocap, dinocap, 2,6-dinitro-anilines such as fluazinam, pyr-hydrazones such as ferimzone, tri-phenyl tin compounds such as fentin acetate, fentin chloride, fentin hydroxide, thiophene-carboxamides such as silthiofam, triazolo-pyrimidylamine such as ametoctradin.

In an embodiment, amino acids and protein synthesis inhibitor fungicides may be selected from anilino-pyrimidines such as cyprodinil, mepanipyrim, pyrimethanil, antibiotic fungicides such as blasticidin-S, kasugamycin, streptomycin, oxytetracycline and the like.

In an embodiment, signal transduction inhibitor fungicides may be selected from aryloxyquinolines such as quinoxyfen, quinazolinones such as proquinazid, phenylpyrroles such as fenpiclonil, fludioxonil, dicarboximides such as chlozolinate, dimethachlone, iprodione, procymidone and vinclozolin.

In an embodiment, the third fungicide may be selected from lipid synthesis and membrane integrity distruptors such as phosphoro-thiolates such as edifenphos, Iprobenfos, pyrazophos, dithiolanes such as isoprothiolane, aromatic hydrocarbons such as biphenyl, chloroneb, dicloran, quintozene (PCNB), tecnazene (TCNB), tolclofos-methyl and the like, 1,2,4-thiadiazoles such as etridiazole, carbamates such as iodocarb, propamocarb, prothiocarb and the like.

Thus in an embodiment, the sterol biosynthesis inhibitors may be selected from triazoles such as azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, Ipconazole, metconazole, myclobutanil, penconazole, Propiconazole, simeconazole, tebuconazole, tetraconazole, triadimefon, triadimenol, triticonazole, prothioconazole, piperazines such as triforine, pyridines such as pyrifenox, pyrisoxazole, pyrimidines such as fenarimol, nuarimol imidazoles such as imazalil, oxpoconazole, pefurazoate, prochloraz, triflumizole, morpholines such as aldimorph, dodemorph, fenpropimorph, tridemorph and the like, piperidines such as fenpropidin, piperalin, spiroketal-amines such as spiroxamine, hydroxyanilides such as fenhexamid, amino-pyrazolinones such as fenpyrazamine, thiocarbamates such as pyributicarb, allylamines such as naftifine, terbinafine and mixtures thereof.

In an embodiment, cell wall biosynthesis inhibitor fungicides may be selected from peptidyl pyrimidine nucleoside fungicides such as polyoxin, cinnamic acid amides such as dimethomorph, flumorph, pyrimorph, valinamide carbamates such as benthiavalicarb, iprovalicarb, valifenalate, mandelic acid amides such as mandipropamid and mixtures thereof.

In an embodiment, melanin synthesis inhibitor fungicide may be selected from isobenzo-furanone such as fthalide, pyrrolo-quinolinones such as pyroquilon, triazolobenzo-thiazoles such as tricyclazole, cyclopropane-carboxamides such as carpropamid, carboxamides such as diclocymet, propionamides such as fenoxanil, trifluoroethyl-carbamates such as tolprocarb, and mixtures thereof.

In an embodiment, host plant defense inductor fungicides may be selected from benzo-thiadiazoles such as acibenzolar-S-methyl, benzisothiazoles such as probenazole, thiadiazole-carboxamides such as tiadinil, isotianil, polysaccharides such as laminarin, and mixtures thereof.

In another embodiment, the ergosterol biosynthesis inhibitors may be selected from prothioconazole, tebuconazole, hexaconazole, cyroconazole or epoxiconazole.

In an embodiment, the systemic fungicide may be a Quinone outside (QoI) inhibitor fungicide selected from azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, dimoxystrobin, fenaminostrobin, metominostrobin, trifloxystrobin, famoxadone, fluoxastrobin, fenamidone, pyribencarb and mixtures thereof.

In an embodiment, the Quinone outside inhibitor (QoI) fungicide may be selected from azoxystrobin, picoxystrobin, kresoxim-methyl, pyraclostrobin and trifloxystrobin.

In an embodiment, the third systemic fungicide is selected from a quinone outside inhibitor, quinone inside inhibitor, demethylation inhibitor, and/or succinate dehydrogenase inhibitor; wherein:

(i) the quinone outside inhibitor is selected from fenamidone, famoxadone, and a strobilurin fungicide selected from the group consisting of azoxystrobin, mandestrobin, coumoxystrobin, enoxastrobin, flufenoxystrobin, pyraoxystrobin, dimoxystrobin, enestrobin, fluoxastrobin, kresoxim-methyl, metominostrobin, orysastrobin, picoxystrobin, pyrametostrobin, triclopyricarb, fenaminstrobin, pyraclostrobin and trifloxystrobin;

(ii) the demethylation inhibitor is selected from triflumizole, triforine, pyridinitrile, pyrifenox, fenarimol, nuarimol, triarimol and a conazole fungicide selected from the group consisting of climbazole, clotrimazole, imazalil, oxpoconazole, prochloraz, prochloraz-manganese, triflumizole, azaconazole, bitertanol, bromuconazole, cyproconazole, diclobutrazol, difenoconazole, diniconazole, diniconazole-M, epoxiconazole, etaconazole, fenbuconazole, fluotrimazole, fluquinconazole, flusilazole, flutriafol, furconazole, furconazole-cis, hexaconazole, imibenconazole, ipconazole, metconazole, myclobutanil, pencoconazole, propiconazole, prothioconazole, quinconazole, simeconazole, tebuconazole, tetraconazole, triadimefon, triadimenol, triticonazole, uniconazole, perfurazoate and uniconazole-P;

(iii) the quinone inside inhibitor selected from cyazofamid and amisulbrom; and

(iv) a succinate dehydrogenase inhibitor selected from the group consisting of benodanil, flutolanil, mepronil, fluopyram, fenfuram, carboxin, oxycarboxin, thifluzamide, bixafen, fluxapyroxad, furametpyr, isopyrazam, penflufen, penthiopyrad, sedaxane and boscalid.

In an embodiment, the multisite fungicide is selected from the group consisting of copper (different salts), sulphur, ferbam, mancozeb, maneb, metiram, propineb, thiram, zinc thiazole, zineb, ziram, captan, captafol, folpet, chlorothalonil, dichlofluanid, Tolylfluanid, guazatine, iminoctadine, anilazine, dithianon, chinomethionat/quinomethionate, fluoroimide, and methasulfocarb.

In an embodiment, the dithiocarbamate fungicide is selected from the group consisting of amobam, asomate, azithiram, carbamorph, cufraneb, cuprobam, disulfiram, ferbam, metam, nabam, tecoram, thiram, urbacide, ziram, dazomet, etem, milneb, mancopper, mancozeb, maneb, metiram, polycarbamate, propineb and zineb.

In an embodiment, there is provided a synergistic fungicidal combination for controlling saprophytic pathogenic fungi, wherein the combination comprises:

(i) ipconazole;

(ii) thiabendazole; and

(iii) one or more additional fungicides.

In an embodiment, there is provided a synergistic fungicidal combination for controlling Rhizoctonia sp., wherein the combination comprises:

(i) ipconazole;

(ii) thiabendazole; and

(iii) one or more additional fungicides.

In an embodiment, there is provided a synergistic fungicidal combination for controlling Sclerotinia sclerotiorum sp., wherein the combination comprises:

(i) ipconazole;

(ii) thiabendazole; and

(iii) one or more additional fungicides.

In an embodiment, there is provided a synergistic fungicidal combination for controlling saprophytic pathogenic fungi, wherein the combination comprises:

(i) ipconazole;

(ii) thiabendazole; and

(iii) metalaxyl or metalaxyl-m.

In an embodiment, there is provided a synergistic fungicidal combination for controlling saprophytic pathogenic fungi, wherein the combination comprises:

(i) ipconazole;

(ii) thiabendazole; and

(iii) carboxin.

In an embodiment, there is provided a synergistic fungicidal combination for controlling saprophytic pathogenic fungi, wherein the combination comprises:

(i) ipconazole;

(ii) thiabendazole;

(iii) metalaxyl or metalaxyl-m; and

(iv) carboxin.

In an embodiment, there is provided a synergistic fungicidal combination for controlling saprophytic pathogenic fungi, wherein the combination comprises:

(i) ipconazole;

(ii) thiabendazole; and

(iii) thiram.

In an embodiment, there is provided a synergistic fungicidal combination for controlling saprophytic pathogenic fungi, wherein the combination comprises:

(i) ipconazole;

(ii) thiabendazole; and

(iii) fluazinam.

In an embodiment, there is provided a synergistic fungicidal combination for controlling saprophytic pathogenic fungi, wherein the combination comprises:

(i) ipconazole;

(ii) thiabendazole; and

(iii) cyazofamid.

In an embodiment, there is provided a synergistic fungicidal combination for controlling saprophytic pathogenic fungi, wherein the combination comprises:

(i) ipconazole;

(ii) thiabendazole; and

(iii) fluopyram.

In an embodiment, there is provided a synergistic fungicidal combination for controlling saprophytic pathogenic fungi, wherein the combination comprises:

(i) ipconazole;

(ii) thiabendazole;

(iii) metalaxyl or metalaxyl-m; and

(iv) carboxin.

In an embodiment, there is provided a synergistic fungicidal combination for controlling saprophytic pathogenic fungi, wherein the combination comprises:

(i) ipconazole;

(ii) thiabendazole; and

(iii) one or more insecticides.

In an embodiment, there is provided a synergistic fungicidal combination for controlling Rhizoctonia sp., wherein the combination comprises:

(i) ipconazole;

(ii) thiabendazole; and

(iii) one or more insecticides.

In an embodiment, there is provided a synergistic fungicidal combination for controlling Sclerotinia sclerotiorum, wherein the combination comprises:

(i) ipconazole;

(ii) thiabendazole; and

(iii) one or more insecticides.

In an embodiment, the insecticide is from one or more of acetylcholinesterase (AChE) inhibitors, ryanodine receptor modulators, GAB A-gated chloride channel blockers, sodium channel modulators, nicotinic acetylcholine receptor (nAChR) competitive modulators, glutamate-gated chloride channel (GluCl) allosteric modulators, chordotonal organ TRPV channel modulators, Inhibitors of mitochondrial ATP synthase, mite growth inhibitors affecting CHS1, moulting disruptors, microbial disruptors of insect midgut membranes, Inhibitors of acetyl CoA carboxylase, mitochondrial complex electron transport inhibitors, ecdysone receptor agonists, inhibitors of chitin biosynthesis, and the like.

In an embodiment, the insecticide is from one or more of ryanodine receptor modulator comprising chlorantraniliprole, cyantraniliprole, cyclaniliprole, flubendiamide, and tetraniliprole.

In an embodiment, the insecticide is from one or more of acetylcholinesterase (AChE) inhibitors comprising carbamates and organophosphates.

In an embodiment, the insecticide is from one or more of nicotinic acetylcholine receptor (nAChR) competitive modulators, comprising neonicotinoids comprising acetamiprid, clothianidin, dinotefuran, imidacloprid, nitenpyram, thiacloprid, and thiamethoxam.

In an embodiment, the insecticide is from one or more of sodium channel modulators comprising pyrethroids and pyrethrins comprising acrinathrin, allethrin, d-cis-trans allethrin, d-trans allethrin, bifenthrin, bioallethrin, bioallethrin S-cyclopentenyl isomer, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, [(1R)-trans-isomers], deltamethrin, empenthrin (EZ)-[(1R)-isomers], esfenvalerate, etofenprox, fenpropathrin, fenvalerate, flucythrinate, flumethrin, tau-fluvalinate, halfenprox, imiprothrin, kadethrin, permethrin, phenothrin [(1R)-trans-isomer], prallethrin, pyrethrins (pyrethrum), resmethrin, silafluofen, tefluthrin, tetramethrin, tetramethrin [(1R)-isomers], tralomethrin, and transfluthrin.

In an embodiment, there is provided a synergistic fungicidal combination for controlling saprophytic pathogenic fungi, wherein the combination comprises:

(i) ipconazole;

(ii) thiabendazole; and

(iii) flupyrimin.

In an embodiment, there is provided a synergistic fungicidal combination for controlling saprophytic pathogenic fungi, wherein the combination comprises:

(i) ipconazole;

(ii) thiabendazole; and

(iii) flonicamid.

In an embodiment, there is provided a synergistic fungicidal combination for controlling saprophytic pathogenic fungi, wherein the combination comprises:

(i) ipconazole;

(ii) thiabendazole; and

(iii) chlorantraniliprole.

In an embodiment, there is provided a synergistic fungicidal combination for controlling saprophytic pathogenic fungi, wherein the combination comprises:

(i) ipconazole;

(ii) thiabendazole; and

(iii) cyantraniliprole.

In an embodiment, there is provided a synergistic fungicidal combination for controlling saprophytic pathogenic fungi, wherein the combination comprises:

(i) ipconazole;

(ii) thiabendazole; and

(iii) clothianidin.

In an embodiment, there is provided a synergistic fungicidal combination for controlling saprophytic pathogenic fungi, wherein the combination comprises:

(i) ipconazole;

(ii) thiabendazole; and

(iii) thiamethoxam.

In an embodiment, there is provided a synergistic fungicidal combination for controlling saprophytic pathogenic fungi, wherein the combination comprises:

(i) ipconazole;

(ii) thiabendazole; and

(iii) imidacloprid.

In an embodiment, there is provided a synergistic fungicidal combination for controlling saprophytic pathogenic fungi, wherein the combination comprises:

(i) ipconazole;

(ii) thiabendazole; and

(iii) fipronil.

In an embodiment, there is provided a synergistic fungicidal combination for controlling saprophytic pathogenic fungi, wherein the combination comprises:

(i) ipconazole;

(ii) thiabendazole; and

(iii) one or more fungicides and insecticides.

In an embodiment, there is provided a synergistic fungicidal combination for controlling Rhizoctonia sp., wherein the combination comprises:

(i) ipconazole;

(ii) thiabendazole; and

(iii) one or more fungicides and insecticides.

In an embodiment, there is provided a synergistic fungicidal combination for controlling Sclerotinia sclerotiorum, wherein the combination comprises:

(i) ipconazole;

(ii) thiabendazole; and

(iii) one or more fungicides and insecticides.

In an embodiment, there is provided a synergistic fungicidal combination for controlling saprophytic pathogenic fungi, wherein the combination comprises:

(i) ipconazole;

(ii) thiabendazole;

(iii) metalaxyl or metalaxyl-m; and

(iv) one or more of flupyrimin or flonicamid or chlorantraniliprole or cyantraniliprole or clothianidin or thiamethoxam or imidacloprid or fipronil.

In an embodiment, there is provided a synergistic fungicidal combination for controlling saprophytic pathogenic fungi, wherein the combination comprises:

(i) ipconazole;

(ii) thiabendazole;

(iii) carboxin; and

(iv) one or more of flupyrimin or flonicamid or chlorantraniliprole or cyantraniliprole or clothianidin or thiamethoxam or imidacloprid or fipronil.

In an embodiment, there is provided a synergistic fungicidal combination for controlling saprophytic pathogenic fungi, wherein the combination comprises:

(i) ipconazole;

(ii) thiabendazole;

(iii) thiram; and

(iv) one or more of flupyrimin or flonicamid or chlorantraniliprole or cyantraniliprole or clothianidin or thiamethoxam or imidacloprid or fipronil.

In an embodiment, there is provided a synergistic fungicidal combination for controlling saprophytic pathogenic fungi, wherein the combination comprises:

(i) ipconazole;

(ii) thiabendazole;

(iii) fluazinam; and

(iv) one or more of flupyrimin or flonicamid or chlorantraniliprole or cyantraniliprole or clothianidin or thiamethoxam or imidacloprid or fipronil.

In an embodiment, there is provided a synergistic fungicidal combination for controlling saprophytic pathogenic fungi, wherein the combination comprises:

(i) ipconazole;

(ii) thiabendazole;

(iii) cyazofamid; and

(iv) one or more of flupyrimin or flonicamid or chlorantraniliprole or cyantraniliprole or clothianidin or thiamethoxam or imidacloprid or fipronil.

In an embodiment, there is provided a synergistic fungicidal combination for controlling saprophytic pathogenic fungi, wherein the combination comprises:

(i) ipconazole;

(ii) thiabendazole;

(iii) fluopyram; and

(iv) one or more of flupyrimin or flonicamid or chlorantraniliprole or cyantraniliprole or clothianidin or thiamethoxam or imidacloprid or fipronil.

The actives of the combination of the present invention maybe applied simultaneously as a tank mix or may be applied sequentially or as a formulation. The application may be made to the soil before emergence of the plants, either at the pre-planting or post-planting stage. The application may be made as a foliar spray at different timings during crop development, with either one or two applications early or late post-emergence. More preferably, the combination of the present invention is applied to a plant propagation material.

In some embodiments, the combinations according to the present disclosure are used to treat plant propagation materials.

In some embodiments, the combinations according to the present disclosure are used to treat seeds, a type of plant propagation materials.

The combinations of present disclosure used for plant propagation materials treatment are efficacious in protecting the materials and/or the plant originating from them during target fungi's life cycle in which it causes injury to the seed or plant.

In an aspect, the present disclosure provides a fungicidal composition for controlling phytopathogenic fungi comprising:

(i) at least one demethylation inhibitor fungicide;

(ii) at least one β-tubulin assembly inhibitor fungicide; and

(iii) one or more agrochemically acceptable excipients.

In an embodiment, the present disclosure provides a fungicidal composition for controlling saprophytic phytopathogenic fungi comprising:

(i) at least one demethylation inhibitor fungicide;

(ii) at least one β-tubulin assembly inhibitor fungicide; and

(iii) one or more agrochemically acceptable excipients.

In an embodiment, there is provided a synergistic fungicidal composition for controlling Rhizoctonia fungi, wherein the combination comprises:

(i) at least one demethylation inhibitor fungicide;

(ii) at least one β-tubulin assembly inhibitor fungicide; and

(iii) one or more agrochemically acceptable excipients.

In an embodiment, the present disclosure provides a synergistic fungicidal composition for controlling Sclerotinia sclerotiorum fungi comprising:

(i) at least one demethylation inhibitor fungicide;

(ii) at least one β-tubulin assembly inhibitor fungicide; and

(iii) one or more agrochemically acceptable excipients.

In an embodiment, the present disclosure provides a fungicidal composition for controlling phytopathogenic fungi comprising demethylation inhibitor fungicide in a concentration ranging from 1% to 100% w/v or 1% to 99% w/v of the composition, β-tubulin assembly inhibitor fungicide in a concentration ranging from 1% to 100% w/v or 1% to 99% w/v of the composition and one or more agrochemically acceptable excipients in a concentration ranging from 1% to 50% w/v of the composition.

In an embodiment, the present disclosure provides a fungicidal composition for controlling phytopathogenic fungi comprising demethylation inhibitor fungicide in a concentration ranging from 1% to 80% w/v of the composition, β-tubulin assembly inhibitor fungicide in a concentration ranging from 1% to 80% w/v of the composition and one or more agrochemic ally acceptable excipients in a concentration ranging from 1% to 30% w/v of the composition.

In an embodiment, the present disclosure provides a fungicidal composition for controlling phytopathogenic fungi comprising demethylation inhibitor fungicide in a concentration ranging from 1% to 60% w/v of the composition, β-tubulin assembly inhibitor fungicide in a concentration ranging from 1% to 60% w/v of the composition and one or more agrochemic ally acceptable excipients in a concentration ranging from 1% to 30% w/v of the composition.

In an embodiment, the present disclosure provides a fungicidal composition for controlling phytopathogenic fungi comprising demethylation inhibitor fungicide in a concentration ranging from 1% to 40% w/v of the composition, β-tubulin assembly inhibitor fungicide in a concentration ranging from 1% to 40% w/v of the composition and one or more agrochemic ally acceptable excipients in a concentration ranging from 1% to 30% w/v of the composition.

In an embodiment, the present disclosure provides a fungicidal composition for controlling phytopathogenic fungi comprising demethylation inhibitor fungicide in a concentration ranging from 1% to 20% w/v of the composition, β-tubulin assembly inhibitor fungicide in a concentration ranging from 1% to 20% w/v of the composition and one or more agrochemic ally acceptable excipients in a concentration ranging from 1% to 30% w/v of the composition.

In another embodiment, the demethylation inhibitor fungicide comprises azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, ipconazole, mefentrifluconazole, metconazole, myclobutanil, penconazole, propiconazole, simeconazole, tebuconazole, tetraconazole, triadimefon, triadimenol, triticonazole, prothioconazole, or a combination thereof.

In a preferred embodiment, the demethylation inhibitor fungicide is ipconazole.

In another embodiment, the β-tubulin assembly inhibitor fungicide comprises of benomyl, carbendazim, fuberidazole, thiabendazole, thiophanate, thiophanate-methyl, or a combination thereof.

In a preferred embodiment, the β-tubulin assembly inhibitor fungicide is thiabendazole.

In an embodiment, the present disclosure provides a fungicidal composition for controlling phytopathogenic fungi comprising ipconazole, thiabendazole and one or more agrochemically acceptable excipients.

In an embodiment, the present disclosure provides a fungicidal composition for controlling phytopathogenic fungi comprising ipconazole in a concentration ranging from 1% to 100% w/v or 1% to 99% w/v of the composition, thiabendazole in a concentration ranging from 1% to 100% w/v or 1% to 99% w/v of the composition and one or more agrochemically acceptable excipients in a concentration ranging from 1% to 50% w/v of the composition.

In an embodiment, the present disclosure provides a fungicidal composition for controlling phytopathogenic fungi comprising ipconazole in a concentration ranging from 1% to 80% w/v of the composition, thiabendazole in a concentration ranging from 1% to 80% w/v of the composition and one or more agrochemically acceptable excipients in a concentration ranging from 1% to 30% w/v of the composition.

In an embodiment, the present disclosure provides a fungicidal composition for controlling phytopathogenic fungi comprising ipconazole in a concentration ranging from 1% to 60% w/v of the composition, thiabendazole in a concentration ranging from 1% to 60% w/v of the composition and one or more agrochemically acceptable excipients in a concentration ranging from 1% to 30% w/v of the composition.

In an embodiment, the present disclosure provides a fungicidal composition for controlling saprophytic phytopathogenic fungi comprising ipconazole, thiabendazole and one or more agrochemically acceptable excipients.

In an embodiment, there is provided, a fungicidal composition for controlling Rhizoctonia sp., said composition comprising ipconazole, thiabendazole and one or more agrochemically acceptable excipients.

In an embodiment, there is provided, a fungicidal composition for controlling Rhizoctonia solani, said composition comprising ipconazole, thiabendazole and one or more agrochemically acceptable excipients.

In an embodiment, the present disclosure provides a fungicidal composition for controlling Sclerotinia sp., said composition comprising ipconazole, thiabendazole and one or more agrochemically acceptable excipients.

In an embodiment, the present disclosure provides a fungicidal composition for controlling Sclerotinia sclerotiorum, said composition comprising ipconazole, thiabendazole and one or more agrochemically acceptable excipients.

In an embodiment, the present disclosure provides a fungicidal composition for controlling phytopathogenic fungi comprising ipconazole in a concentration ranging from 1% to 80% w/v of the composition, thiabendazole in a concentration ranging from 1% to 80% w/v of the composition and one or more agrochemically acceptable excipients in a concentration ranging from 1% to 30% w/v of the composition.

The composition that is used to treat seeds in the present disclosure can be in the form of a soluble concentrate (SL, LS), a dispersible concentrate (DC), an emulsifiable concentrate (EC), a suspension (SC, OD, FS), an emulsion (EW, EO, ES), a slurry of particles in an aqueous medium (e.g. water), a paste, a water-dispersible or water-soluble powder (WP, SP, SS, WS), a pastille, a water-dispersible or water-soluble granule (WG, SG), a dry granule (GR, FG, GG, MG), a gel formulation (GF) and a dustable powder (DP, DS). Water-soluble concentrates (LS), flowable concentrates (FS), powders for dry treatment (DS), water-dispersible powders for slurry treatment (WS), water-soluble powders (SS), emulsions (ES), emulsifiable concentrates (EC) and gels (GF) are usually employed for the purposes of treatment of seeds.

In an embodiment, the agrochemically acceptable excipient are selected from the group consisting of surfactants, antifreeze agents, wetting agents, antifoaming agents, thickening agents, preservatives, colorants, fillers, and combinations thereof.

In a preferred embodiment, the composition is present in a form of suspension concentrate, flowable concentrate or any suitable liquid formulation.

In an embodiment the formulation includes a surfactant mix comprising a non-ionic surfactant and an anionic surfactant.

In an embodiment of the present invention, the non-ionic surfactant comprises non-ionic surfactants such as polyalkyleneoxide siloxanes, ethoxylated derivatives of fatty alcohols, alkyl glucosides, alkyl phenols, polyalkylene glycol ethers and condensation products of alkyl phenols, amines, fatty acids, fatty esters, mono-, di-, or triglycerides, various block copolymeric surfactants derived from alkylene oxides such as ethylene oxide (E0)/propylene oxide (PO), aliphatic amines or fatty acids with ethylene oxides and/or propylene oxides such as the ethoxylated alkyl phenols or ethoxylated aryl or polyaryl phenols, carboxylic esters solubilized with a polyol or polyvinyl alcohol/polyvinyl acetate copolymers, polyvinyl alcohol, polyvinyl pyrrolidinones and acrylic acid graft copolymers and mixtures, reaction products, and/or copolymers thereof, and combinations thereof.

In a preferred embodiment, non-ionic surfactant of the surfactant mix comprises various block copolymeric surfactants derived from alkylene oxides such as ethylene oxide/propylene oxide, aliphatic amines or fatty acids with ethylene oxides and/or propylene oxides such as the ethoxylated alkyl phenols or ethoxylated aryl or polyaryl phenols, their mixtures, reaction products, and/or copolymers thereof, and combinations thereof.

In an embodiment, the composition comprises from about 0.1% to about 50% w/w and preferably from about 1% to about 40% w/w non-ionic surfactant of the total weight of the agrochemical composition.

In an embodiment, the anionic surfactant comprises alkyl and aryl sulfates and sulfonates, including sodium alky sulfates, sodium mono- and di-alkyl naphthalene sulfonates, sodium alpha-olefin sulfonate, lignin and its derivatives (such as lignosulfonate salts, sodium lignosulfonate), sodium alkane sulfonates, polyoxyalkyene alkylether sulfate, polyoxyalkylene alkylaiyl ether sulfates, polyoxy-alkylene styrylphenyl ether sulfate, mono- and di-alkylbenzene sulfonates, alkylnaphthalene sulfonate, alkylnaphthalene sulfonate formaldehyde condensate, alkyl diphenylether sulfonates, olefine sulfonates, alkylphosphates, polyoxyalkylene alkyl phosphates, polyoxyalkylene phenylether phosphate, polyoxyalkylphenol phosphates, poly-carboxylates, fatty acids and salts thereof, alkyl glycinates, sulfonated methyl esters, sulfonated fatty acids, sulfosuccinates and their derivatives, acyl glutamates, acyl sarcosinates, alkyl sulfoacetates, acylated peptides, alkyl ether carboxylates, acyl lactylates, anionic fluorosurfactants, amid ether sulfates, N-methyl fatty acid taurides, mixtures thereof and the like, including sodium, potassium, ammonium and amine salts, etc., and combinations thereof.

In a preferred embodiment, the anionic surfactant comprises alkyl and aryl sulfates and sulfonates, including sodium alky] sulfates, sodium mono- and di-alkyl naphthalene sulfonates, lignin, and its derivatives (such as lignosulfonate salts), polyoxyalkyene alkylether sulfate, alkylnaphthalene sulfonate, alkylnaphthalene sulfonate formaldehyde condensate, and combinations thereof.

In an embodiment, the composition comprises from about 0.1% to about 50% w/w and preferably from about 1% to about 40% w/w of anionic surfactant of the total weight of composition.

In an embodiment the composition may further comprise one or more antifreeze agents, wetting agents, fillers, anticaking agents, pH-regulating agents, preservatives, biocides, antifoaming agents, colorants and other formulation aids.

In an embodiment, the composition may further comprise one or more agriculturally acceptable excipients selected from the group consisting of antifreeze agent, wetting agent, antifoaming agent, thickening agent, preservative, colorant, filler, and combinations thereof.

Exemplary antifreeze agents that can be added to the agrochemical composition are liquid polyols, for example ethylene glycol, propylene glycol or glycerol.

Wetting agents that can be added to the agrochemical composition of the present invention include, but are not limited to: polyarylalkoxylated phosphate esters and their potassium salts (e.g., Soprophor® FLK, Stepfac™ TSP PE-K. Other wetting agents include sodium dioctylsulfosuccinates (e.g., Geropon® SDS, Aerosol® OT) and ethoxylated alcohols (e.g., Trideceth-6, Rhodasurf® BC 610, and Tersperse® 4894).

Optionally, about 0.1% to about 5.0% w/w of antifoam or defoamers are employed to stop any unwanted foam generated while manufacturing a highly concentrated liquid biocide dispersion composition, for example. The preferred antifoaming agent comprises silicone-based compounds, alcohols, glycol ethers, mineral spirits, acetylene diols, polysiloxanes, organosiloxanes, siloxane glycols, reaction products of silicon dioxide and organosiloxane polymer, polydimethylsiloxanes or polyalkylene glycols alone or in combination. Defoamers that are suitable include SAG™ Antifoams (e.g., SAG-10; SAG-1000AP; SAG-1529; SAG-1538; SAG-1571; SAG-1572; SAG-1575; SAG-2001; SAG-220; SAG-290; SAG-30; SAG-30E; SAG-330; SAG-47; SAG-5440; SAG-7133 and SAG-770).

Examples of thickening agents based on anionic heteropolysaccharides from the xanthan gum group are inter alia the Rhodopol 23®, Rhodopol G®, Rhodopol 50 MD®, Rhodicare T®, Kelzan®, Kelzan S® and Satiaxane CX91®.

Preservatives used may be benzisothiazolinone (Proxel™ GXL) or phenols, 2-bromo-2-nitropropane-1,3-diol (Bioban™ BP 30), 5-chloro-2-methyl-4-isothiazolin-3-one & 2 methyl-4-isothiazolin-3 one (Kathon™ CG/ICP), Glutaraldehyde (Ucarcide™ 50), Chloromethylisothiazolinone (CMIT)/Methylisothiazolinone (MIT) (Isocil™ Ultra 1.5), 2,2-dibromo-3-nitrilopropioamide (Reputain™ D20), Natamycin & Nisin, Bronopol/CMIT/MIT (Mergal® 721K3).

Exemplary colorants include pigments which are sparingly soluble in water, and dyes, which are water-soluble. Examples are inorganic coloring agents including iron oxide, titanium oxide, and iron hexacyanoferrate and organic coloring agents including alizarin, azo and phthalocyanin coloring agents.

In an embodiment, the composition of the present disclosure is a seed treatment composition.

In an embodiment, the seed treatment composition is a suspension concentrate (SC), emulsifiable concentrate (EC), flowable concentrate, flowable suspension (FS), Microemulsion (ME), Oil Dispersion (OD) or suspoemulsion (SE).

In an embodiment, the present disclosure provides a seed treatment composition for controlling phytopathogenic fungi comprising:

(i) at least one demethylation inhibitor fungicide;

(ii) at least one β-tubulin assembly inhibitor fungicide; and

(iii) one or more agrochemically acceptable excipients.

In an embodiment, the present disclosure provides a seed treatment composition for controlling saprophytic phytopathogenic fungi comprising:

(i) at least one demethylation inhibitor fungicide;

(ii) at least one β-tubulin assembly inhibitor fungicide; and

(iii) one or more agrochemically acceptable excipients.

In an embodiment, the present disclosure provides a seed treatment composition for controlling Rhizoctonia sp., wherein the composition comprises:

(i) at least one demethylation inhibitor fungicide;

(ii) at least one β-tubulin assembly inhibitor fungicide; and

(iii) one or more agrochemically acceptable excipients.

In an embodiment, the present disclosure provides a seed treatment composition for controlling Rhizoctonia solani, wherein the composition comprises:

(i) at least one demethylation inhibitor fungicide;

(ii) at least one β-tubulin assembly inhibitor fungicide; and

(iii) one or more agrochemically acceptable excipients.

In an embodiment, the present disclosure provides a seed treatment composition for controlling Sclerotinia sp. comprising:

(i) at least one demethylation inhibitor fungicide;

(ii) at least one β-tubulin assembly inhibitor fungicide; and

(iii) one or more agrochemically acceptable excipients.

In an embodiment, the present disclosure provides a seed treatment composition for controlling Sclerotinia sclerotiorum fungi comprising:

(i) at least one demethylation inhibitor fungicide;

(ii) at least one β-tubulin assembly inhibitor fungicide; and

(iii) one or more agrochemically acceptable excipients.

In an embodiment, the present disclosure provides a seed treatment composition for controlling phytopathogenic fungi comprising demethylation inhibitor fungicide in a concentration ranging from 1% to 100% w/v or 1% to 99% w/v of the composition, β-tubulin assembly inhibitor fungicide in a concentration ranging from 1% to 100% w/v or 1% to 99% w/v of the composition and an inert filler in a concentration ranging from 1% to 50% w/v of the composition.

In an embodiment, the present disclosure provides a seed treatment composition for controlling phytopathogenic fungi comprising a demethylation inhibitor fungicide in a concentration ranging from 1% to 80% w/v of the composition, a β-tubulin assembly inhibitor fungicide in a concentration ranging from 1% to 80% w/v of the composition and an inert filler in a concentration ranging from 1% to 30% w/v of the composition.

In an embodiment, the present disclosure provides a seed treatment composition for controlling phytopathogenic fungi, said composition comprising ipconazole, thiabendazole and one or more agrochemically acceptable excipients.

In an embodiment, the present disclosure provides a seed treatment composition for controlling saprophytic phytopathogenic fungi, said composition comprising ipconazole, thiabendazole and one or more agrochemically acceptable excipients.

In an embodiment, the agrochemically acceptable excipient is selected from an auxiliary agent, coating agent or an inert filler.

In an embodiment, the present disclosure provides a seed treatment composition for controlling phytopathogenic fungi comprising ipconazole in a concentration ranging from 1% to 100% w/v or 1% to 99% w/v of the composition, thiabendazole in a concentration ranging from 1% to 100% w/v or 1% to 99% w/v of the composition and an agrochemically acceptable excipient in a concentration ranging from 1% to 50% w/v of the composition.

In an embodiment, the present disclosure provides a seed treatment composition for controlling phytopathogenic fungi comprising ipconazole in a concentration ranging from 1% to 80% w/v of the composition, thiabendazole in a concentration ranging from 1% to 80% w/v of the composition and an agrochemically acceptable excipient in a concentration ranging from 1% to 30% w/v of the composition.

In an embodiment, the present disclosure provides a seed treatment composition for controlling phytopathogenic fungi comprising ipconazole in a concentration ranging from 1% to 60% w/v of the composition, thiabendazole in a concentration ranging from 1% to 60% w/v of the composition and an agrochemically acceptable excipient in a concentration ranging from 1% to 30% w/v of the composition.

In an embodiment, the present disclosure provides a seed treatment composition for controlling phytopathogenic fungi comprising ipconazole in a concentration ranging from 1% to 40% w/v of the composition, thiabendazole in a concentration ranging from 1% to 40% w/v of the composition and an agrochemically acceptable excipient in a concentration ranging from 1% to 30% w/v of the composition.

In an embodiment, the present disclosure provides a seed treatment composition for controlling phytopathogenic fungi comprising ipconazole in a concentration ranging from 1% to 20% w/v of the composition, thiabendazole in a concentration ranging from 1% to 20% w/v of the composition and an agrochemically acceptable excipient in a concentration ranging from 1% to 30% w/v of the composition.

In an embodiment, the present disclosure provides a seed treatment composition for controlling phytopathogenic fungi comprising ipconazole in a concentration ranging from 1% to 100% w/v or 1% to 99% w/v of the composition, thiabendazole in a concentration ranging from 1% to 100% w/v or 1% to 99% w/v of the composition and an inert filler in a concentration ranging from 1% to 50% w/v of the composition.

In an embodiment, the present disclosure provides a seed treatment composition for controlling phytopathogenic fungi comprising ipconazole in a concentration ranging from 1% to 80% w/v of the composition, thiabendazole in a concentration ranging from 1% to 80% w/v of the composition and an inert filler in a concentration ranging from 1% to 30% w/v of the composition.

In an embodiment, the present disclosure provides a seed treatment composition for controlling phytopathogenic fungi comprising ipconazole in a concentration ranging from 1% to 60% w/v of the composition, thiabendazole in a concentration ranging from 1% to 60% w/v of the composition and an inert filler in a concentration ranging from 1% to 30% w/v of the composition.

In an embodiment, the present disclosure provides a seed treatment composition for controlling phytopathogenic fungi comprising ipconazole in a concentration ranging from 1% to 40% w/v of the composition, thiabendazole in a concentration ranging from 1% to 40% w/v of the composition and an inert filler in a concentration ranging from 1% to 30% w/v of the composition.

In an embodiment, the present disclosure provides a seed treatment composition for controlling phytopathogenic fungi comprising ipconazole in a concentration ranging from 1% to 20% w/v of the composition, thiabendazole in a concentration ranging from 1% to 20% w/v of the composition and an inert filler in a concentration ranging from 1% to 30% w/v of the composition.

In an embodiment, there is provided, a seed treatment composition for controlling Rhizoctonia sp. comprising ipconazole, thiabendazole and an inert filler.

In an embodiment, there is provided, a seed treatment composition for controlling Rhizoctonia solani comprising ipconazole, thiabendazole and an inert filler.

In an embodiment, the present disclosure provides a seed treatment composition for controlling Sclerotinia sp. comprising ipconazole, thiabendazole and an inert filler.

In an embodiment, the present disclosure provides a seed treatment composition for controlling Sclerotinia sclerotiorum comprising ipconazole, thiabendazole and one or more agrochemically acceptable excipients.

The seed treatment composition according to the present invention comprises at least one inert filler or an auxiliary agent that is specifically conducive for the seed treatment. The inert filler or the auxiliary agent promotes adhesion of the active ingredient to and/or penetration into the layers of the seeds and/or otherwise improves stability of the composition and/or manageability of the seeds treated therewith. Thus, the seed treatment composition of the present invention comprises at least one auxiliary agent(s) selected from a coating agent, filler, binders or plasticizers, or polymers.

Fillers may include an organic or inorganic solid inert substance such as talc, clay, diatomaceous earth, magnesium aluminum silicate, white carbon black, pyrophyllite, light calcium carbonate, high clay, organic bentonite, etc., and mixtures thereof.

The filler can be an absorbent or an inert filler, such as are known in the art, and may include wood flours, cereal flours, tree bark mill, wood meal and nutshell meal, sugars, in particular polysaccharides, activated carbon, fine-grain inorganic solids, silica gels, silicates, clays, chalk, diatomaceous earth, calcium carbonate, magnesium carbonate, dolomite, magnesium oxide, calcium sulfate and the like. Clays and inorganic solids which may be used include calcium bentonite, kaolin, china clay, talc, perlite, mica, vermiculite, silicates, quartz powder, montmorillonite, attapulgite, bole, loess, limestone, lime and mixtures thereof. Sugars which may be useful include dextrin and maltodextrin. Cereal flours include wheat flour, oat flour and barley flour. The filler may also comprise fertilizer substances such as, for example, ammonium sulphate, ammonium phosphate, ammonium nitrate, urea, and mixtures thereof.

The binder or polymer may be selected from polyesters, polyether esters, polyanhydrides, polyester urethanes, polyester amides; polyvinyl acetates; polyvinyl acetate copolymers; polyvinyl alcohols and tylose; polyvinyl alcohol copolymers; polyvinylpyrolidones; polysaccharides, including starches, modified starches and starch derivatives, dextrins, maltodextrins, alginates, chitosanes and celluloses, cellulose esters, cellulose ethers and cellulose ether esters including ethylcelluloses, methylcelluloses, hydroxymethylcelluloses, hydroxypropylcelluloses and carboxymethylcellulose; fats; oils; proteins, including casein, gelatin and zeins; gum arabics; shellacs; vinylidene chloride and vinylidene chloride copolymers; lignosulfonates, in particular calcium lignosulfonates; polyacrylates, polymethacrylates and acrylic copolymers; polyvinylacrylates; polyethylene oxide; polybutenes, polyisobutenes, polystyrene, polyethyleneamines, polyethylenamides; acrylamide polymers and copolymers; polyhydroxyethyl acrylate, methylacrylamide monomers; polychloroprene, and combinations thereof.

In an embodiment, the amount of auxiliary agent will not exceed 10% by weight. Preferably, the amount of the auxiliary agent does not exceed 5% by weight and 1% by weight, based on the total weight of the composition.

Further auxiliary agents that may be present in the seed treatment composition include solvents, wetting agent, dispersants, emulsifiers, surfactants, thickeners, protective colloids, antifoams, and preservatives.

In an embodiment, the present disclosure provides a seed treatment composition for controlling saprophytic, phytopathogenic fungi comprising ipconazole in a concentration ranging from 1% to 80% w/v of the composition, thiabendazole in a concentration ranging from 1% to 80% w/v of the composition and an inert filler in a concentration ranging from 1% to 50% w/v of the composition.

In an embodiment, the present disclosure provides a seed treatment composition for controlling saprophytic, phytopathogenic fungi comprising ipconazole in a concentration ranging from 1% to 60% w/v, 1% to 40% w/v, 1% to 20% w/v of the composition, thiabendazole in a concentration ranging from 1% to 60% w/v, 1% to 40% w/v, 1% to 20% w/v of the composition and an inert filler in a concentration ranging from 1% to 30% w/v of the composition.

According to an embodiment of the present disclosure, a kit-of-parts comprising a fungicide composition is provided. The kit comprises a plurality of components, each of which components may include at least one of the ingredients of the fungicide composition of the present disclosure.

An embodiment of the present invention discloses a kit-of-parts comprising a fungicide composition of a demethylation inhibitor, a β-tubulin assembly inhibitor fungicide and/or agrochemically acceptable excipient.

An embodiment of the present invention discloses a kit-of-parts comprising ipconazole, thiabendazole and/or agrochemically acceptable excipient.

One or more of the components may already be combined or pre-formulated. In those embodiments where more than two components are provided in a kit, the components may already be combined and as such are packaged in a single container such as a vial, bottle, can, pouch, bag, or canister.

The fungicidal combinations and compositions of present disclosure may be applied to the locus of the plant on one or more occasions during the growth of the plant. It can be applied to the planting site before the seed is sown, during the sowing of the seed, pre-emergence and/or post-emergence. The combinations and compositions can also be used while the plant is being grown in a green house and the use can be continued after transplantation. The soil may, for example, be treated directly, prior to transplanting, at transplanting or after transplanting. The use of the compositions can be via any suitable method, which ensures that the agents penetrate the soil, for example, nursery tray application, in furrow application, soil drenching, soil injection, drip irrigation, application through sprinklers or central pivot, incorporation into soil (broad cast or in band) are such methods.

The rate and frequency of use of the compositions on the plant may vary within wide limits and depends on type of use, specific active agents, nature of the soil, method of application (pre- or post-emergence, etc.), the plant, the prevailing climatic conditions, and other factors governed by the method of application, the time of application and the target plant.

The treatment according to the disclosure of the plants and plant parts with the active compound or its compositions is carried out directly or by action on their surroundings, habitat or storage space using customary treatment methods, for example by dipping, spraying, atomizing, irrigating, evaporating, dusting, fogging, broadcasting, foaming, painting, spreading-on, watering (drenching), drip irrigating and, in the case of propagation material, in particular in the case of seeds, furthermore as a powder for dry seed treatment, a solution for seed treatment, a water-soluble powder for slurry treatment, by incrusting, by coating with one or more layers, etc. It is furthermore possible to apply the active compound in combination with other active(s) by the ultra-low volume method, or to inject the active compound combination into the soil.

In an embodiment, when employed in plant protection, the amount of active substance applied is in the range, depending on the kind of effect desired, from 0.001 to 10 kg per ha, preferably from 0.001 to 5 kg per ha or 0.001 to 2 kg per ha preferably from 0.005 to 1 kg per ha, in particular from 0.005 to 0.5 kg per ha.

The actives of the combination of the present invention maybe applied simultaneously as a tank mix or may be applied sequentially or as a formulation. The application may be made to the soil before emergence of the plants, either at the pre-planting or post-planting stage. The application may be made as a foliar spray at different timings during crop development, with either one or two applications early or late post-emergence. More preferably, the combination of the present invention is applied to a plant propagation material.

In another embodiment, the seeds can be subjected to spraying, coating, or soaking. The process of coating seeds denotes any process that endows the outer surfaces of the seeds partially or completely with a layer or layers of the present fungicidal combination or composition. According to this method the seeds are cleaned and afterwards coated with a diluted formulation by using e.g., a rotating pot-mixer for about several minutes and followed by reversible rotation followed by drying.

In an embodiment, the coating of the plant or plant propagation material or seed can be done by any method known in the art.

In a preferred embodiment the plant or plant propagation material or seed is sown or planted in the soil or pots or nurseries.

In a preferred embodiment the sowing of plant or plant propagation material or seed is done by line sowing.

The seed treatment combination can also comprise or may be applied together and/or sequentially with further active compounds. These further compounds can be selected from fertilizers or micronutrient donors or microorganisms or other preparations that influence plant growth, such as inoculants (e.g., a strain of nitrogen-fixing bacteria), plant inducers.

In an embodiment, the method of the present disclosure increases the disease resistance in a plant or plant propagation material.

In an embodiment, the plant propagation material is a seed, rhizome, or tuber.

In a preferred embodiment, the plant propagation material is a seed.

In a preferred embodiment, the plant propagation material is of crops selected from the group of brassicas, such as broccoli, Chinese broccoli, Brussels sprouts, cauliflower, Cavalo broccoli, kohlrabi, cabbage, Chinese cabbage and Chinese mustard cabbage; cilantro; coriander; corn, cucurbits, such as chayote, Chinese wax gourd, citron melon, cucumber, gherkin, gourd, muskmelons (including cantaloupe, casaba, crenshaw melon, golden pershaw melon, honeydew melon, honey balls, mango melon, Persian melon, pineapple melon, Santa Claus melon and snake melon), pumpkins, summer squash, winter squash and watermelon; dried beans and peas, including bean, field bean, kidney bean, lima bean, pinto bean, navy bean, tepary bean, adzuki bean, black eyed pea, catjang, cowpea, crowder pea, moth bean, mung bean, rice bean, southern pea, urd bean, broad bean, chickpea, guar, lablab bean, lentil, pea, field pea and pigeon pea; eggplant; lettuce; leafy brassicas/turnip greens including broccoli rabe, Bok choy, collards, kale, mizuna, mustard spinach, rape greens and turnip greens; okra; peppers; sod; soybeans; spinach; succulent peas and beans including pea, sunflower, dwarf pea, edible-pod pea, English pea, garden pea, green pea, snow pea, sugar snap pea, pigeon pea, bean, broadbean, lima bean, runner bean, snap bean, wax bean, asparagus bean, yardlong bean, jackbean and sword bean; tobacco; tomatoes; and tuberous and corm vegetables including potato, sweet potato, arracacha, arrowroot, Chinese artichoke, Jerusalem artichoke, edible canna, cassava, chayote, chufa, dasheen, ginger, lerén, tanier, turmeric, yam bean and true yam.

In an embodiment, the seed is selected from the group of beans, field bean, kidney bean, lima bean, pinto bean, navy bean, tepary bean, adzuki bean, black eyed pea, soybeans, succulent peas and beans including pea, dwarf pea, edible-pod pea, English pea, garden pea, green pea, snow pea, sugar snap pea, pigeon pea, bean, broad bean, lima bean, runner bean, snap bean, wax bean.

In a preferred embodiment, the seed may be selected from soybean seed, orange seed, rice seed raspberries seed, broccoli seed, prune seed, corn seed, peach seed, mango seed, celery seed, conifer seed, tangerine seed, kiwifruit seed, gooseberry seed, plum seed, pumpkin seed, beet seed, starfruit seed, bean seed, asparagus seed, apple seed, crab apple seed, swiss chard seed, and many more.

In an embodiment, tubers include potatoes, carrots, parsnips, turnips, beetroot, sweet-potato and taro.

In a preferred embodiment, the seed is a legume comprising chickpea, peanut, black bean, green pea, lima bean, kidney bean, black-eyed pea, navy bean and soybeans.

In a preferred embodiment, the seed is a soybean seed.

In another preferred embodiment, the seed is selected from cereals.

In another embodiment, the seed is a row crop seed or an oil seed.

In an embodiment, the present fungicide combination comprising ipconazole and thiabendazole can be applied to seeds, in diluted or undiluted form.

In an embodiment, the present fungicide composition comprising ipconazole and thiabendazole can be applied to seeds, in diluted or undiluted form.

In an embodiment, the present invention provides a method of controlling phytopathogenic fungi in crops comprising applying a fungicidal combination comprising at least one demethylation inhibitor fungicide; and at least one β-tubulin assembly inhibitor fungicide; wherein the weight ratio of the demethylation inhibitor fungicide and the β-tubulin assembly inhibitor fungicide is ranging from 1:100 to 100:1; at a locus of a plant, a plant part or a plant propagation material.

In an embodiment, the present invention provides a method of controlling phytopathogenic fungi in crops comprising applying a fungicidal combination comprising at least one demethylation inhibitor fungicide; and at least one β-tubulin assembly inhibitor fungicide; wherein the weight ratio of the demethylation inhibitor fungicide and the β-tubulin assembly inhibitor fungicide is ranging from 1:10 to 10:1; at a locus of a plant, a plant part or a plant propagation material.

In an embodiment, the present invention provides a method of controlling saprophytic, phytopathogenic fungi in crops comprising applying a fungicidal combination comprising at least one demethylation inhibitor fungicide; and at least one β-tubulin assembly inhibitor fungicide; wherein the ratio of the demethylation inhibitor fungicide and the β-tubulin assembly inhibitor fungicide is ranging from 1:10 to 10:1; at a locus of a plant, a plant part or a plant propagation material.

In an embodiment, the present invention provides a method of controlling phytopathogenic fungi in crops comprising applying a fungicidal combination comprising at least one demethylation inhibitor fungicide; and at least one β-tubulin assembly inhibitor fungicide; wherein the ratio of the demethylation inhibitor fungicide and the β-tubulin assembly inhibitor fungicide is ranging from 1:5 to 5:1; at a locus of a plant, a plant part or a plant propagation material.

In a preferred embodiment, the present invention provides a method of controlling phytopathogenic fungi in crops comprising applying a fungicidal combination comprising at least one demethylation inhibitor fungicide; and at least one β-tubulin assembly inhibitor fungicide; wherein the ratio of the demethylation inhibitor fungicide and the β-tubulin assembly inhibitor fungicide is 1:8; at a locus of a plant, a plant part or a plant propagation material.

In a preferred embodiment, the present invention provides a method of controlling phytopathogenic fungi in crops comprising applying a fungicidal combination comprising at least one demethylation inhibitor fungicide; and at least one β-tubulin assembly inhibitor fungicide; wherein the ratio of the demethylation inhibitor fungicide and the β-tubulin assembly inhibitor fungicide is 1:6; at a locus of a plant, a plant part or a plant propagation material.

In an embodiment, the present invention provides a method of controlling phytopathogenic fungi in crops comprising applying at a locus of a plant, a plant part or a plant propagation material a combination comprising ipconazole, thiabendazole in a weight ratio ranging from 1:100 to 100:1.

In an embodiment, the present invention provides a method of controlling phytopathogenic fungi in crops comprising applying at a locus of a plant, a plant part or a plant propagation material a combination comprising ipconazole, thiabendazole in a weight ratio ranging from 1:10 to 10:1.

In an embodiment, the present invention provides a method of controlling saprophytic, phytopathogenic fungi in crops comprising applying at a locus of a plant, a plant part or a plant propagation material a combination comprising ipconazole, thiabendazole in a weight ratio ranging from 1:10 to 10:1.

In an embodiment, the present invention provides a method of controlling phytopathogenic fungi in crops comprising applying at a locus of a plant, a plant part or a plant propagation material a combination comprising ipconazole, thiabendazole in a weight ratio ranging from 1:5 to 5:1.

In another embodiment, the present invention provides a method of controlling phytopathogenic fungi in crops comprising applying at a locus of a plant, a plant part or a plant propagation material a combination comprising ipconazole, thiabendazole in a weight ratio of 1:8.

In another embodiment, the present invention provides a method of controlling phytopathogenic fungi in crops comprising applying at a locus of a plant, a plant part or a plant propagation material a combination comprising ipconazole, thiabendazole in a weight ratio of 1:6.

In another embodiment, the present invention provides a method of controlling phytopathogenic fungi in crops comprising applying a plant propagation material with a combination comprising ipconazole, thiabendazole in a weight ratio ranging from 1:10 to 10:1.

In another embodiment, the present invention provides a method of controlling phytopathogenic fungi in crops comprising applying seeds with a combination comprising ipconazole, thiabendazole in a weight ratio ranging from 1:10 to 10:1.

In another embodiment, the present invention provides a method of controlling phytopathogenic fungi in crops comprising applying seeds with a combination comprising ipconazole, thiabendazole in a weight ratio ranging from 1:5 to 5:1.

In another embodiment, the present invention provides a method of controlling phytopathogenic fungi in crops comprising applying seeds with a combination comprising ipconazole and thiabendazole in a weight ratio of 1:8.

In another embodiment, the present invention provides a method of controlling phytopathogenic fungi in crops comprising applying seeds with a combination comprising ipconazole and thiabendazole in a weight ratio of 1:6.

In an embodiment, the present invention provides a method of controlling phytopathogenic fungi in crops comprising applying seeds with a combination comprising:

(i) a demethylation inhibitor fungicide applied at an application rate ranging from 1 g/100 kg of seeds to 50 g/100 kg of seeds; and

(ii) a β-tubulin assembly inhibitor fungicide applied at an application rate ranging from 1 g/100 kg of seeds to 100 g/100 kg of seeds.

In an embodiment, the present invention provides a method of controlling phytopathogenic fungi in crops comprising applying seeds with a combination comprising:

(i) a demethylation inhibitor fungicide applied at an application rate ranging from 1 g/100 kg of seeds to 20 g/100 kg of seeds; and

(ii) a β-tubulin assembly inhibitor fungicide applied at an application rate ranging from 1 g/100 kg of seeds to 80 g/100 kg of seeds.

In another embodiment, the present invention provides a method of controlling phytopathogenic fungi in crops comprising applying seeds with a combination comprising:

(i) a demethylation inhibitor fungicide applied at an application rate ranging from 1 g/100 kg of seeds to 10 g/100 kg of seeds; and

(ii) a β-tubulin assembly inhibitor fungicide applied at an application rate ranging from 1 g/100 kg of seed to 75 g/100 kg of seeds.

In another embodiment, the present invention provides a method of controlling phytopathogenic fungi in crops comprising applying seeds with a combination comprising:

(i) a demethylation inhibitor fungicide applied at an application rate ranging from 1 g/100 kg of seeds to 8 g/100 kg of seeds; and

(ii) a β-tubulin assembly inhibitor fungicide applied at an application rate ranging from 1 g/100 kg of seed to 70 g/100 kg of seeds.

In an embodiment, the present invention provides a method of controlling phytopathogenic fungi in crops comprising applying seeds with a combination comprising:

(i) ipconazole applied at an application rate ranging from 1 g/100 kg of seeds to 50 g/100 kg of seeds; and

(ii) thiabendazole applied at an application rate ranging from 1 g/100 kg of seeds to 100 g/100 kg of seeds.

In an embodiment, the present invention provides a method of controlling phytopathogenic fungi in crops comprising applying seeds with a combination comprising:

(i) ipconazole applied at an application rate ranging from 1 g/100 kg of seeds to 20 g/100 kg of seeds; and

(ii) thiabendazole applied at an application rate ranging from 1 g/100 kg of seeds to 80 g/100 kg of seeds.

In another embodiment, the present invention provides a method of controlling phytopathogenic fungi in crops comprising applying onto seeds a combination comprising:

(i) ipconazole applied at an application rate ranging from 1 g/100 kg of seeds to 10 g/100 kg of seeds; and

(ii) thiabendazole applied at an application rate ranging from 1 g/100 kg of seeds to 75 g/100 kg of seeds.

In another embodiment, the present invention provides a method of controlling phytopathogenic fungi in crops comprising applying seeds with a combination comprising:

(i) ipconazole applied at an application rate ranging from 1 g/100 kg of seeds to 8 g/100 kg of seeds; and

(ii) thiabendazole applied at an application rate ranging from 1 g/100 kg of seeds to 70 g/100 kg of seeds.

The method of controlling fungal infestation in crops using the present combination, fungicidal composition and the seed treatment composition results in synergistic control of the target phytopathogens.

In an embodiment, the present invention provides a method comprising applying soybean seeds with a fungicide combination comprising:

(i) a demethylation inhibitor fungicide applied at an application rate ranging from 1 g/100 kg of seeds to 50 g/100 kg of seeds; and

(ii) a β-tubulin assembly inhibitor fungicide at an application rate ranging from 1 g/100 kg of seeds to 100 g/100 kg of seeds.

In an embodiment, the present invention provides a method comprising applying soybean seeds with a fungicide combination comprising:

(i) a demethylation inhibitor fungicide applied at an application rate ranging from 1 g/100 kg of seeds to 20 g/100 kg of seeds; and

(ii) a β-tubulin assembly inhibitor fungicide at an application rate ranging from 1 g/100 kg of seeds to 80 g/100 kg of seeds.

In another embodiment, the present invention provides a method comprising applying soybean seeds with a fungicide combination comprising:

(i) a demethylation inhibitor fungicide applied at an application rate ranging from 1 g/100 kg of seed to 10 g/100 kg of seeds; and

(ii) a β-tubulin assembly inhibitor fungicide applied at an application rate ranging from 1 g/100 kg of seed to 75 g/100 kg of seeds.

In another embodiment, the present invention provides a method comprising applying soybean seeds with a fungicide combination comprising:

(i) a demethylation inhibitor fungicide applied at an application rate ranging from 1 g/100 kg of seeds to 8 g/100 kg of seeds; and

(ii) a β-tubulin assembly inhibitor fungicide applied at an application rate ranging from 1 g/100 kg of seed to 70 g/100 kg of seeds.

In another embodiment, the present invention provides a method comprising applying soybean seeds with a fungicide combination comprising:

(i) a demethylation inhibitor fungicide applied at an application rate ranging from 1 g/100 kg of seeds to 8 g/100 kg of seeds; and

(ii) a β-tubulin assembly inhibitor fungicide applied at an application rate ranging from 1 g/100 kg of seeds to 70 g/100 kg of seeds.

wherein at least 70% synergistic control of the phytopathogenic fungi is obtained.

In another embodiment, the present invention provides a method comprising applying soybean seeds with a fungicide combination comprising:

(i) a demethylation inhibitor fungicide applied at an application rate ranging from 1 g/100 kg of seeds to 8 g/100 kg of seeds; and

(ii) a β-tubulin assembly inhibitor fungicide applied at an application rate ranging from 1 g/100 kg of seeds to 70 g/100 kg of seeds.

wherein at least 80% synergistic control of the phytopathogenic fungi is obtained.

In an embodiment, the present invention provides a method comprising applying soybean seeds with a fungicide combination comprising:

(i) ipconazole applied at an application rate ranging from 1 g/100 kg of seeds to 50 g/100 kg of seeds; and

(ii) thiabendazole applied at an application rate ranging from 1 g/100 kg of seeds to 100 g/100 kg of seeds.

In an embodiment, the present invention provides a method comprising applying soybean seeds with a fungicide combination comprising:

(i) ipconazole applied at an application rate ranging from 1 g/100 kg of seeds to 20 g/100 kg of seeds; and

(ii) thiabendazole applied at an application rate ranging from 1 g/100 kg of seeds to 80 g/100 kg of seeds.

In another embodiment, the present invention provides a method comprising applying soybean seeds with a fungicide combination comprising:

(i) ipconazole applied at an application rate ranging from 1 g/100 kg of seeds to 10 g/100 kg of seeds; and

(ii) thiabendazole applied at an application rate ranging from 1 g/100 kg of seeds to 70 g/100 kg of seeds.

In another embodiment, the present invention provides a method comprising applying soybean seeds with a fungicide combination comprising:

(i) ipconazole applied at an application rate ranging from 1 g/100 kg of seeds to 8 g/100 kg of seeds; and

(ii) thiabendazole at an application rate ranging from 1 g/100 kg of seeds to 70 g/100 kg of seeds.

In an embodiment, the present invention provides a method comprising applying soybean seeds with a fungicide combination for effectively controlling saprophytic phytopathogenic fungi, the combination comprising:

(i) ipconazole applied at an application rate ranging from 1 g/100 kg of seeds to 50 g/100 kg of seeds; and

(ii) thiabendazole applied at an application rate ranging from 1 g/100 kg of seeds to 100 g/100 kg of seeds.

In an embodiment, the present invention provides a method comprising applying soybean seeds with a fungicide combination for effectively controlling saprophytic phytopathogenic fungi, the combination comprising:

(i) ipconazole applied at an application rate ranging from 1 g/100 kg of seeds to 20 g/100 kg of seeds; and

(ii) thiabendazole applied at an application rate ranging from 1 g/100 kg of seeds to 80 g/100 kg of seeds.

In another embodiment, the present invention provides a method comprising applying soybean seeds with a combination for effectively controlling saprophytic phytopathogenic fungi, the combination comprising:

(i) ipconazole applied at an application rate ranging from 1 g/100 kg of seeds to 10 g/100 kg of seeds; and

(ii) thiabendazole applied at an application rate ranging from 1 g/100 kg of seeds to 75 g/100 kg of seeds.

In another embodiment, the present invention provides a method comprising applying soybean seeds with a combination for effectively controlling saprophytic phytopathogenic fungi, the combination comprising:

(i) ipconazole applied at an application rate ranging from 1 g/100 kg of seeds to 8 g/100 kg of seeds; and

(ii) thiabendazole applied at an application rate ranging from 1 g/100 kg of seeds to 70 g/100 kg of seeds.

In an embodiment, the present invention provides a method comprising applying soybean seeds with a fungicide combination for effectively controlling Rhizoctonia solani, the combination comprising:

(i) ipconazole applied at an application rate ranging from 1 g/100 kg of seeds to 50 g/100 kg of seeds; and

(ii) thiabendazole applied at an application rate ranging from 1 g/100 kg of seeds to 100 g/100 kg of seeds.

In an embodiment, the present invention provides a method comprising applying soybean seeds with a fungicide combination for effectively controlling Rhizoctonia solani, the combination comprising:

(i) ipconazole applied at an application rate ranging from 1 g/100 kg of seeds to 20 g/100 kg of seeds; and

(ii) thiabendazole applied at an application rate ranging from 1 g/100 kg of seeds to 80 g/100 kg of seeds.

In another embodiment, the present invention provides a method comprising applying soybean seeds with a combination for effectively controlling Rhizoctonia solani, the combination comprising:

(i) ipconazole applied at an application rate ranging from 1 g/100 kg of seeds to 10 g/100 kg of seeds; and

(ii) thiabendazole applied at an application rate ranging from 1 g/100 kg of seeds to 75 g/100 kg of seeds.

In another embodiment, the present invention provides a method comprising applying soybean seeds with a combination for effectively controlling Rhizoctonia solani, the combination comprising:

(i) ipconazole applied at an application rate ranging from 1 g/100 kg of seeds to 8 g/100 kg of seeds; and

(ii) thiabendazole applied at an application rate ranging from 1 g/100 kg of seeds to 70 g/100 kg of seeds.

In an embodiment, the present invention provides a method comprising applying soybean seeds with a fungicide combination for effectively controlling Sclerotinia sclerotiorum, the combination comprising:

(i) ipconazole applied at an application rate ranging from 1 g/100 kg of seeds to 50 g/100 kg of seeds; and

(ii) thiabendazole applied at an application rate ranging from 1 g/100 kg of seeds to 100 g/100 kg of seeds.

In an embodiment, the present invention provides a method comprising applying soybean seeds with a fungicide combination for effectively controlling Sclerotinia sclerotiorum, the combination comprising:

(i) ipconazole applied at an application rate ranging from 1 g/100 kg of seeds to 20 g/100 kg of seeds; and

(ii) thiabendazole applied at an application rate ranging from 1 g/100 kg of seeds to 80 g/100 kg of seeds.

In another embodiment, the present invention provides a method comprising applying soybean seeds with a combination for effectively controlling Sclerotinia sclerotiorum, the combination comprising:

(i) ipconazole applied at an application rate ranging from 1 g/100 kg of seeds to 10 g/100 kg of seeds; and

(ii) thiabendazole applied at an application rate ranging from 1 g/100 kg of seeds to 75 g/100 kg of seeds.

In another embodiment, the present invention provides a method comprising applying soybean seeds with a combination for effectively controlling Sclerotinia sclerotiorum, the combination comprising:

(i) ipconazole applied at an application rate ranging from 1 g/100 kg of seeds to 8 g/100 kg of seeds; and

(ii) thiabendazole applied at an application rate ranging from 1 g/100 kg of seeds to 70 g/100 kg of seeds.

A combination is said to be “Synergistic” when its observed efficacy of the combination is greater than the expected efficacy. The expected efficacy (E) is calculated using the following equation also called as Colby's formula:

E=(X+Y)−XY/100

In the above equation, X is the efficacy of demethylation inhibitor fungicide and Y is the efficacy of β-tubulin assembly inhibitor fungicide.

In an embodiment, the present invention provides the use of a fungicidal combination for controlling fungal infestation in crops comprising:

(i) applying a demethylation inhibitor fungicide at an application rate ranging from 1 g/100 kg of seed to 20 g/100 kg of seeds; and

(ii) applying a β-tubulin assembly inhibitor fungicide at an application rate ranging from 1 g/100 kg of seed to 70 g/100 kg of seeds;

wherein the fungal infestation in crops is caused by saprophytic, phytopathogenic fungi.

In an embodiment, the present invention provides the use of a fungicidal combination for controlling fungal infestation in crops comprising:

(i) applying ipconazole at an application rate ranging from 1 g/100 kg of seed to 20 g/100 kg of seeds; and

(ii) applying thiabendazole at an application rate ranging from 1 g/100 kg of seed to 70 g/100 kg of seeds;

wherein the fungal infestation in crops is caused by saprophytic, phytopathogenic fungi.

In an embodiment, the present invention provides the use of a fungicidal combination for controlling fungal infestation in crops comprising:

(i) applying ipconazole at an application rate ranging from 1 g/100 kg of seed to 10 g/100 kg of seeds; and

(ii) applying thiabendazole at an application rate ranging from 1 g/100 kg of seed to 70 g/100 kg of seeds;

wherein the fungal infestation in crops is caused by saprophytic, phytopathogenic fungi.

In an embodiment, the present invention provides the use of a fungicidal combination for controlling fungal infestation in crops comprising:

(i) applying ipconazole at an application rate ranging from 1 g/100 kg of seed to 10 g/100 kg of seeds; and

(ii) applying thiabendazole at an application rate ranging from 1 g/100 kg of seed to 70 g/100 kg of seeds;

wherein the fungal infestation in crops is caused by saprophytic, phytopathogenic fungi;

wherein the fungicidal combination is suitable for seed treatment.

In another embodiment, the present invention provides the use of a fungicidal combination for controlling fungal infestation, said combination comprising ipconazole, and thiabendazole for controlling fungal infestation caused by phytopathogenic saprophytic fungi in crops.

In another embodiment, the present invention provides the use of a fungicidal combination suitable for seed treatment.

In still another embodiment, the combinations of present disclosure are used to treat soybean seeds.

In still another embodiment, the fungicides in the combinations according to the present disclosure are formulated together and applied as a pre-emergence and/or a post-emergence of crops.

In still another embodiment, the fungicides in the combinations according to the present disclosure are formulated separately and applied sequentially.

In still another embodiment, the fungicides in the combinations according to the present disclosure are applied to the soil.

In still another embodiment, the fungicides in the combinations according to the present disclosure are applied to the soil shortly after sowing in an in furrow-treatment.

The combinations or compositions according to the present disclosure are effective for controlling the plant diseases including the following ones:

Diseases in sorghum, for example: leaf blight and banded leaf;

Diseases in bean, for example: leaf blight, web blight and root rot;

Diseases in crimson clover, for example: summer blight;

Diseases in camphor seedlings, for example: southern blight;

Diseases in turfgrass, for example s: brown patch and large patch;

Diseases in cabbage, for example: rot;

Diseases in lettuce, for example: bottom rot;

Diseases in buckwheat, for example: damping off;

Diseases in carrot, for example: damping off and crown root rot;

Diseases in tulip, for example: leaf blight;

Diseases in Japanese radish, for example: root rot;

Diseases in edible burdock, for example: black scurf;

Diseases in konjac, for example: root rot;

Diseases in cereals, for example: bare patches;

Disease in rice: blast (Magnaporthe grisea), helminthosporium leaf spot (Cochliobolus miyabeanus), sheath blight (Rhizoctonia solani), and bakanae disease (Gibberella fujikuroi);

Diseases in wheat: powdery mildew (Erysiphe graminis), Fusarium head blight (Fusarium graminearum, F. avenacerum, F. culmorum, Microdochium nivale), rust (Puccinia striiformis, P. graminis, P. recondita), pink snow mold (Micronectriella nivale), Typhula snow blight (Typhula sp.), loose smut (Ustilago tritici), bunt (Tilletia caries), eyespot (Pseudocercosporella herpotrichoides), leaf blotch (Mycosphaerella graminicola), glume blotch (Stagonospora nodorum), septoria, and yellow spot (Pyrenophora tritici-repentis);

Diseases of barley: powdery mildew (Erysiphe graminis), Fusarium head blight (Fusarium graminearum, F. avenacerum, F. culmorum, Microdochium nivale), rust (Puccinia striiformis, P. graminis, P. hordei), loose smut (Ustilago nuda), scald (Rhynchosporium secalis), net blotch (Pyrenophora teres), spot blotch (Cochliobolus sativus), leaf stripe (Pyrenophora graminea), and Rhizoctonia damping-off (Rhizoctonia solani);

Diseases in corn: smut (Ustilago maydis), brown spot (Cochliobolus heterostrophus), copper spot (Gloeocercospora sorghi), southern rust (Puccinia polysora), gray leaf spot (Cercospora zeae-maydis), white spot (Phaeosphaeria maydis and/or Pantoea ananatis) and Rhizoctonia damping-off (Rhizoctonia solani);

Diseases of citrus: melanose (Diaporthe citri), scab (Elsinoe fawcetti), penicillium rot (Penicillium digitatum, P. italicum), and brown rot (Phytophthora parasitica, Phytophthora citrophthora);

Diseases of apple: blossom blight (Monilinia mali), canker (Valsa ceratosperma), powdery mildew (Podosphaera leucotricha), Alternaria leaf spot (Alternaria alternata apple pathotype), scab (Venturia inaequalis), powdery mildew, bitter rot (Colletotrichum acutatum), crown rot (Phytophtora cactorum), blotch (Diplocarpon mali), and ring rot (Botryosphaeria berengeriana);

Diseases of pear: scab (Venturia nashicola, V. pirina), powdery mildew, black spot (Alternaria alternata Japanese pear pathotype), rust (Gymnosporangium haraeanum), and phytophthora fruit rot (Phytophtora cactorum);

Diseases of peach: brown rot (Monilinia fructicola), powdery mildew, scab (Cladosporium carpophilum), and phomopsis rot (Phomopsis sp.);

Diseases of grape: anthracnose (Elsinoe ampelina), ripe rot (Glomerella cingulata), powdery mildew (Uncinula necator), rust (Phakopsora ampelopsidis), black rot (Guignardia bidwellii), botrytis, and downy mildew (Plasmopara viticola);

Diseases of Japanese persimmon: anthracnose (Gloeosporium kaki), and leaf spot (Cercospora kaki, Mycosphaerella nawae);

Diseases of gourd: anthracnose (Colletotrichum lagenarium), powdery mildew (Sphaerotheca fuliginea), gummy stem blight (Mycosphaerella melonis), Fusarium wilt (Fusarium oxysporum), downy mildew (Pseudoperonospora cubensis), Phytophthora rot (Phytophthora sp.), and damping-off (Pythium sp.);

Diseases of tomato: early blight (Alternaria solani), leaf mold (Cladosporium fulvum), and late blight (Phytophthora infestans), leaf blight and fruit rot;

Diseases of eggplant: brown spot (Phomopsis vexans), and powdery mildew (Erysiphe cichoracearum), brown spot;

Diseases of cruciferous vegetables: Alternaria leaf spot (Alternaria japonica), white spot (Cercosporella brassicae), clubroot (Plasmodiophora brassicae), and downy mildew (Peronospora parasitica), damping off;

Diseases of onion: rust (Puccinia allii), and downy mildew (Peronospora destructor);

Diseases of soybean: purple seed stain (Cercospora kikuchii), sphaceloma scad (Elsinoe glycines), pod and stem blight (Diaporthe phaseolorum var. sojae), septoria brown spot (Septoria glycines), frogeye leaf spot (Cercospora sojina), rust (Phakopsora pachyrhizi), Yellow rust, brown stem rot (Phytophthora sojae), and Rhizoctonia damping-off (Rhizoctonia solani), leaf blight, damping off, and root rot;

Diseases of kidney bean: anthracnose (Colletotrichum lindemthianum). Diseases of peanut: leaf spot (Cercospora personata), brown leaf spot (Cercospora arachidicola) and southern blight (Sclerotium rolfsii);

Diseases of garden pea and pea: powdery mildew (Erysiphe pisi), stem rot and root rot (Fusarium solani f. sp. pisi);

Diseases in snap bean, for example: pod rot;

Diseases of potato: early blight (Alternaria solani), late blight (Phytophthora infestans), pink rot (Phytophthora erythroseptica), and powdery scab (Spongospora subterranean f. sp. subterranea), black scurf and stem/stolon cankers, and damping off;

Diseases of strawberry: powdery mildew (Sphaerotheca humuli), and anthracnose (Glomerella cingulata);

Diseases of tea: net blister blight (Exobasidium reticulatum), white scab (Elsinoe leucospila), gray blight (Pestalotiopsis sp.), and anthracnose (Colletotrichum theae-sinensis);

Diseases of tobacco: brown spot (Alternaria longipes), powdery mildew (Erysiphe cichoracearum), anthracnose (Colletotrichum tabacum), downy mildew (Peronospora tabacina), and black shank (Phytophthora nicotianae);

Diseases of rapeseed: sclerotinia rot (Sclerotinia sclerotiorum), and Rhizoctonia damping-off (Rhizoctonia solani);

Diseases of cotton: Rhizoctonia damping-off (Rhizoctonia solani);

Diseases of sugar beet: Cercospora leaf spot (Cercospora beticola), damping off, leaf blight (Thanatephorus cucumeris), root rot (Thanatephorus cucumeris), and Aphanomyces root rot (Aphanomyces cochlioides);

Diseases of rose: black spot (Diplocarpon rosae), powdery mildew (Sphaerotheca pannosa), downy mildew (Peronospora sparsa);

Diseases of chrysanthemum and asteraceous plants: downy mildew (Bremia lactucae), leaf blight (Septoria chrysanthemi-indici), and white rust (Puccinia horiana);

Diseases of various groups: diseases caused by Pythium spp. (Pythium aphanidermatum, Pythium debarianum, Pythium graminicola, Pythium irregulare, Pythium ultimum), gray mold. (Botrytis cinerea), and Sclerotinia rot (Sclerotinia sclerotiorum);

Disease of Japanese radish: Alternaria leaf spot (Alternaria brassicicola);

Diseases of turfgrass: dollar spot (Sclerotinia homeocarpa), brown patch and large patch (Rhizoctonia solani);

Disease of banana: black sigatoka (Mycosphaerella fijiensis), yellow sigatoka (Mycosphaerella musicola); and

Disease of sunflower: downy mildew (Plasmopara halstedii).

Seed diseases or diseases in the early stages of the growth of various plants caused by Aspergillus spp., Penicillium spp., Fusarium spp., Gibberella spp., Tricoderma spp., Thielaviopsis spp., Rhizopus spp., Mucor spp., Corticium spp., Phoma spp., Rhizoctonia spp. and Diplodia spp.

Viral diseases of various plants mediated by Polymxa spp., Olpidium spp., and the like.

The present invention provides a synergistic fungicide combination for efficaciously controlling fungal infestation in crops. The present fungicide combination effectively controls pathogenic, saprophytic fungi in crops and reduces the damage due to fungal infestation.

In view of the above, it will be seen that the several advantages of the invention are achieved, and other advantageous results attained.

Although the present invention has been disclosed in full, it will be understood that numerous additional modifications and variations could be made thereto without departing from the scope of the invention.

It will be understood that the specification and examples are illustrative but not limitative of the present disclosure and that other embodiments within the spirit and scope of the invention will suggest themselves to those skilled in the art. Other embodiments can be practiced that are also within the scope of the present invention. The following examples illustrate the invention, but by no means intend to limit the scope of the claims.

### EXAMPLES

### Example 1: Evaluation of Fungicidal Efficacy of Ipconazole and Thiabendazole Combination Against Rhizoctonia solani

A frequently used method for improving the use profile of an agrochemical is the combination of an active compound with one or more other active compounds which contribute to the desired additional properties. However, when two or more active compounds are applied in combination, it is not uncommon for phenomena of physical and biological incompatibility to occur, for example insufficient stability of a joint formulation, decomposition of an active compound or antagonism of the active compounds. What is desired are, in contrast, active compound combinations having a favorable activity profile, high stability and, if possible, synergistically enhanced activity, thus permitting the application rate to be reduced, compared with the individual application of the active compounds to be combined.

Chemical mixtures can have an antagonistic effect when mixed, where the results are less than expected when the chemicals are combined. There can also be an additive effect, where the resultant mixture gives results expected from the sum of its components. Finally, there can be a synergistic effect where the results are greater than expected. A synergistic result is rare and typically only observed in results from high concentrations. In the heavily regulated agrochemical industry, high concentrations are not desirable in the environment. Therefore, when a synergistic effect is achieved at low doses, the resultant mixture is indeed a rare and unexpected finding.

A synergistic effect of an agrochemical is always present when the anti-phytopathogenic activity of the active compound combinations exceeds the total of the activities of the active compounds when applied individually. The expected activity for a given combination of two active compounds can be calculated according to S. R. Colby (“Calculating Synergistic and Antagonistic Responses of Herbicide Combinations”, Weeds 15, (1967), 20-22).

### Colby Calculation

This effectiveness of all treatments as measured by percent reduction in the target phytopathogen growth, was also evaluated according to Colby's equation as below.

If,

X is the percent inhibition of growth by Ipconazole (A) at an application rate,

Y is the percent inhibition of growth by thiabendazole (B) at an application rate, and

E is the expected growth as a percent of control with Ipconazole and thiabendazole, when applying the active compounds, A and B at application rates

Then,

E=X+Y−XY/100 Colby's equation

If the actual/observed anti-phytopathogenic efficacy of the ipconazole and thiabendazole combination against Rhizoctonia solani growth exceeds the calculated value, then the activity of the combination is super additive, i.e., a synergistic effect exists. In this case, the efficacy which was actually observed must be greater than the value for the expected efficacy (E) calculated from the abovementioned formula.

Methodology: Experiments were carried out to evaluate the bio-efficacy of combinations according to the invention of the present disclosure consisting of ipconazole and thiabendazole against Rhizoctonia solani fungi in soybean seeds. The seeds were inoculated with Rhizoctonia solani. The fungicides were tank mixed and applied as seed treatment as described in table 4 below. Spraying volume was 5 ml/kg.

TABLE 4
% CONTROL OF RHIZOCTONIA SOLANI USING
THE COMBINATION OF THE PRESENT INVENTION

| | | | | Observed | | |
|---|---|---|---|---|---|---|
| | | Observed | | efficacy of | | |
| | | efficacy of | | β-tubulin | | |
| | | demethylation | | assembly | Observed | Expected |
| | Treatment | inhibitor | Treatment | inhibitor | efficacy of | efficacy of |
| Sr. | (g a.i./100 | fungicide | (g a.i./100 | fungicide | combination | combination |
| No. | kg seed) | (%) | kg seeds) | (%) | (%) | (%) |
| 1. | Ipconazole | 49.05 | Thiabendazole | 43.39 | 77.35 | 71.16 |
| | 2 gram | | 12 gram | | | |
| | active | | active | | | |
| | ingredient/ | | ingredient/ | | | |
| | 100 kg | | 100 kg | | | |
| 2. | Ipconazole | 67.92 | Thiabendazole | 56.60 | 88.67 | 86.08 |
| | 3 gram | | 18 gram | | | |
| | active | | active | | | |
| | ingredient/ | | ingredient/ | | | |
| | 100 kg | | 100 kg | | | |

The present combination consisting of ipconazole and thiabendazole in its application for seed treatment is synergistic and provides effective control of the saprophytic Rhizoctonia solani fungi.

### Example 2: Evaluation of Fungicidal Efficacy of Ipconazole and Thiabendazole Combination Against Sclerotinia sclerotiorum

Colby Calculation: This effectiveness of all treatments as measured by percent reduction in the target phytopathogen growth, was also evaluated according to Colby's equation as below.

If,

X is the percent inhibition of growth by Ipconazole (A) at an application rate,

Y is the percent inhibition of growth by thiabendazole (B) at an application rate, and

E is the expected growth as a percent of control with Ipconazole and thiabendazole, when applying the active compounds, A and B at application rates

Then,

E=X+Y−XY/100 Colby's equation

If the actual/observed anti-phytopathogenic efficacy of the ipconazole and thiabendazole combination against S. sclerotiorum exceeds the calculated value, then the activity of the combination is super additive, i.e., a synergistic effect exists. In this case, the efficacy which was actually observed must be greater than the value for the expected efficacy (E) calculated from the abovementioned formula.

Methodology: To evaluate the incidence of the pathogen S. sclerotiorum in soybean seeds, the laboratory paper towel roll method was used.

A paper towel on a flat surface was placed and moistened with water until it was thoroughly damp. A sample size of a total of 100 soybean seeds in rows were placed on the towel. The seeds were inoculated with the fungal pathogen. The seeds were pre-treated as per the treatments mentioned in the Table 5. A second towel was moistened and placed onto the first paper towel, leaving the seeds sandwiched between the two towels. It was observed that air space in between the two towels was maintained, if not, excessive water should be removed. The two towels were rolled with the seeds in-between and place in a sealed container that retained the moisture. The paper rolls were placed upright and incubated for 14 days in an incubator at 25° C. and at a 12 h photoperiod in plastic bags, which is used to maintain humidity during the incubation. For each treatment, 400 seeds were analyzed, 8 repetitions with 50 seeds each repetition.

TABLE 5
% CONTROL OF S. SCLEROTIORUM USING THE
COMBINATION OF THE PRESENT INVENTION

| | | | | Observed | | |
|---|---|---|---|---|---|---|
| | | Observed | | efficacy of | | |
| | | efficacy of | | β-tubulin | | |
| | | demethylation | | assembly | Observed | Expected |
| | Treatment | inhibitor | Treatment | inhibitor | efficacy of | efficacy of |
| Sr. | (g a.i./100 | fungicide | (g a.i./100 | fungicide | combination | combination |
| No. | kg seed) | (%) | kg seed) | (%) | (%) | (%) |
| 3. | Inoculated | 0 | — | 0 | — | — |
| | seed | | | | | |
| 4. | Ipconazole | 21.3 | Thiabendazole | 14.6 | 88.8 | 32.79 |
| | 5.6 gram | | 30.9 gram | | | |
| | active | | active | | | |
| | ingredient/ | | ingredient/ | | | |
| | 100 kg | | 100 kg | | | |
| 5. | Ipconazole | 6.7 | Thiabendazole | 67.4 | 88.8 | 69.58 |
| | 7.78 gram | | 61.9 gram | | | |
| | active | | active | | | |
| | ingredient/ | | ingredient/ | | | |
| | 100 kg | | 100 kg | | | |

The present combination consisting of ipconazole and thiabendazole, when used for seed treatment is synergistic and provides effective control of the saprophytic S. sclerotiorum

1. A fungicidal combination for controlling fungal infestation in crops comprising:
(i) at least one demethylation inhibitor fungicide; and
(ii) at least one β-tubulin assembly inhibitor fungicide;
wherein the ratio of the demethylation inhibitor fungicide and the β-tubulin assembly inhibitor fungicide is 1:10 to 10:1.

2. The fungicidal combination as claimed in claim 1, comprising:
(i) the demethylation inhibitor fungicide is selected from one or more of azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, ipconazole, mefentrifluconazole, metconazole, myclobutanil, penconazole, propiconazole, simeconazole, tebuconazole, tetraconazole, triadimefon, triadimenol, triticonazole, prothioconazole, and a combination thereof; and
(ii) the one β-tubulin assembly fungicide is selected from one or more of benomyl, carbendazim, fuberidazole, thiabendazole, thiophanate, thiophanate-methyl, and a combination thereof.

3. The fungicidal combination as claimed in claim 1, comprising (i) ipconazole and (ii) thiabendazole.

4. The fungicidal combination as claimed in claim 1, comprising ipconazole and thiabendazole, wherein the combination is for seed treatment.

5. The fungicidal combination as claimed in claim 1, comprising ipconazole and thiabendazole, wherein the said combination is for controlling saprophytic phytopathogenic fungi infestation.

6. The fungicidal combination as claimed in claim 3, comprising ipconazole and thiabendazole in a ratio of 1:8.

7. The fungicidal combination as claimed in claim 1, further comprising an additional fungicide, herbicide or insecticide.

8. A fungicidal composition for controlling fungal infestation comprising
(i) at least one demethylation inhibitor fungicide;
(ii) at least one β-tubulin assembly inhibitor fungicide; and
(iii) an agriculturally acceptable excipient,
wherein the said composition is for seed treatment.

9. The fungicidal composition as claimed in claim 8, said composition comprising (i) ipconazole and (ii) thiabendazole.

10. The fungicidal composition as claimed in claim 8, wherein the composition is a suspension concentrate (SC), an emulsifiable concentrate (EC), a flowable concentrate, a flowable suspension (FS), a Microemulsion (ME), an Oil Dispersion (OD), or a suspoemulsion (SE).

11. A seed treatment composition for controlling fungal infestation comprising
(i) at least one demethylation inhibitor fungicide;
(ii) at least one β-tubulin assembly inhibitor fungicide; and
(iii) an inert carrier.

12. The seed treatment composition as claimed in claim 11, said composition comprising (i) ipconazole and (ii) thiabendazole.

13. A method of controlling phytopathogenic fungi comprising applying a fungicidal combination comprising at least one demethylation inhibitor fungicide; and at least one β-tubulin assembly inhibitor fungicide; wherein the ratio of the demethylation inhibitor fungicide and the β-tubulin assembly inhibitor fungicide is in a ratio from 1:10 to 10:1; at a locus of a plant, a plant part or a plant propagation material.

14. The method as claimed in claim 13, wherein the at least one demethylation inhibitor fungicide is ipconazole; and at least one β-tubulin assembly inhibitor fungicide is thiabendazole.

15. The method as claimed in claim 14, wherein the ipconazole and thiabendazole are in a ratio of 1:8.

16. The method as claimed in claim 14, wherein the plant propagation material is a seed rhizome or tuber.

17. The method as claimed in claim 16, wherein the method comprises applying the seeds with
(i) ipconazole at an application rate ranging from 1 g/100 kg of seeds to 20 g/100 kg of seeds; and
(ii) thiabendazole at an application rate ranging from 1 g/100 kg of seeds to 80 g/100 kg of seeds.

18. The method as claimed in claim 16, wherein the method comprises applying the seeds with
(i) ipconazole at an application rate ranging from 1 g/100 kg of seed to 10 g/100 kg of seeds; and
(ii) thiabendazole at an application rate ranging from 1 g/100 kg of seed to 75 ml/100 kg of seeds.

19. The method as claimed in claim 16, wherein the method comprises applying the seeds with
(i) ipconazole at an application rate ranging from 1 g/100 kg of seed to 8 g/100 kg of seeds; and
(ii) thiabendazole at an application rate ranging from 1 g/100 kg of seed to 70 g/100 kg of seeds.

20. The method as claimed in claim 13, wherein the phytopathogenic fungi is Rhizoctonia sp., Rhizoctonia solani, Sclerotinia sp., or Sclerotinia sclerotiorum.

21. The method as claimed in claim 13, wherein the plant propagation material is a seed and the seed is a cereal, legume, row crop or oil seed, wherein the seed is a soybean, corn, sunflower, canola seed.

22. The method as claimed in claim 21, comprising applying to the seed a combination of ipconazole and thiabendazole, wherein the ipconazole is applied in an amount ranging from 1 g/100 kg seeds to 20 g/100 kg seeds; and the thiabendazole is applied in an amount ranging from 1 g/100 kg seeds to 80 g/100 kg seeds.

23. The method as claimed in claim 22, wherein the ipconazole is applied in an amount ranging from 1 g/100 kg seeds to 10 g/100 kg seeds; and thiabendazole is applied in an amount ranging from 1 g/100 kg seeds to 70 g/100 kg seeds.

24. A method for seed treatment, comprising applying to the seed the combination of claim 3, wherein the ipconazole is applied in an amount ranging from 1 g/100 kg seeds to 20 g/100 kg seeds; and the thiabendazole is applied in an amount ranging from 1 g/100 kg seeds to 80 g/100 kg seeds.

25. The method as claimed in claim 24, wherein the ipconazole is applied in an amount ranging from 1 g/100 kg seeds to 10 g/100 kg seeds; and thiabendazole is applied in an amount ranging from 1 g/100 kg seeds to 70 g/100 kg seeds.
